(19) United States
(12) Patent Application Publication
(10) Pub. No.: US 2003/0111168 A1
(43) Pub. Date: Jun. 19, 2003

(54) Method for making a refastenable undergarment

(75) Inventors: Christopher Peter Olson, Neenah, WI (US); Joseph Daniel Coenen, Kaukauna, WI (US); Mary Jo Meyer, Neenah, WI (US); Paul Joseph Datta, Appleton, WI (US); Eric Donald Johnson, Larson, WI (US); Sarah Jane Marie Freiburger, Hortonville, WI (US); Jerome Steven Veith, Menasha, WI (US); Heather Schenck Mortell, Neenah, WI (US); Robert Eugene Vogt, Neenah, WI (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/026,123

(22) Filed: Dec. 17, 2001

(51) Int. Cl. B32B 31/00

(52) U.S. Cl. 156/250; 156/256

(57) ABSTRACT

A method of making an undergarment having refastenable side seams (12, 14). The method includes a step of preconditioning a substantially two-dimension web (57) to include at least four refastening surfaces (82-85). The refastenable side seams (12, 14) can be incorporated into undergarments formed from a continuous web (57) in which the pre-forms (21) (that will ultimately result in individual undergarments) are oriented in either the machine direction or the cross-direction. The web (57) can be preconditioned to include refastening surfaces (82-85) on both of what becomes the exterior surface (30) and the body-contacting surface (28) of the undergarments.

### BACKGROUND OF THE INVENTION

The present invention relates to a method of making an undergarment having refastenable side seams from a substantially two-dimensional web.

Garments such as disposable absorbent garments have numerous applications including diapers, training pants, feminine care products, and adult incontinence products. The typical disposable absorbent garment is formed as a composite structure including an absorbent assembly disposed between a liquid permeable bodyside liner and a liquid impermeable outer cover. These components can be combined with other materials and features such as elastic materials and containment structures to form a product that is specifically suited for its intended purposes.

One form of disposable absorbent garment is a two-dimensional product that has open sides. Two-dimensional products, such as conventional diapers and some adult incontinence products, are generally flat and provided in an unfastened configuration. These garments have typically included fasteners such as adhesive tape fasteners or mechanical fasteners such as hook and loop type fasteners that releasably connect the front and back waist portions to secure the product about the wearer. Two-dimensional products can be easily applied or removed while the wearer is lying down.

Another form of disposable absorbent garment is a three-dimensional product with closed sides so that the product has a unitary waist opening and two leg openings. The wearer raises and lowers the garment to apply the product. Three-dimensional products are particularly appealing because the pant has a very garment-like look. Children for instance identify diaper products with babies, and most children do not like being identified with or as babies. Consequently, these children do not want to wear baby diapers, and instead prefer to wear three-dimensional products such as training pants that look like adult underwear. Thus, the switch from a traditional diaper to a more garment-like or underwear-like training pant can be an important step in the toilet training process. Similarly, adults seeking the protection of incontinence products prefer the normalcy of a pant product rather than an incontinence product that must be applied in another fashion. Three-dimensional garments have been designed such that they can be torn to remove the garment from the wearer after it has been soiled.

Recently, prefastened and refastenable disposable absorbent garments have been proposed to provide the advantages of both two-dimensional and three-dimensional products. Prefastened and refastenable products can be applied and/or removed either like a conventional diaper or like a conventional training pant. For use as training pants, for example, there may be times when it would be useful to apply the product like a diaper. For instance, it might be more convenient to apply the product like a diaper when there is a desire not to remove the child's shoes. Because it is difficult to know when a particular mode of applying the garment will be needed, it is beneficial to have a garment that is adaptable to being used either as a diaper or as a pant. This is preferable to keeping both types of garments available. A product that can be applied like either a diaper or a pant permits the interior of the product to be easily checked without having to pull the product downward.

Disposable absorbent garments are typically configured to accommodate a wide range of body shapes and sizes. For the most part, these products perform their absorbent and containment functions better when the articles have a conforming fit to the wearer. In order to provide a more customized fit for individual wearers, the articles can be provided with adjustable fastening features. The fastening features can be opened, adjusted and refastened after the article is donned by the wearer. The capacity of the fastening feature to be adjusted and refastened allows the article to better fit a wider variety of wearers. A “refastenable” feature means that the fastener does not lose its functionality just because it is opened and possibly repositioned. The fastening feature can be adjusted and can still be refastened for maintaining closure of the article.

U.S. Pat. No. 5,779,831 is directed to a “Method and Apparatus for Making an Undergarment Having Overlapping or Butt-Type Side Seams”. This patent is directed to a method of making disposable undergarments that have ultrasonically sealed side seams that can be manually detached for removal of the undergarments. In addition to being ultrasonically sealed, the patent describes that the side seams can also be connected by mechanical fasteners, including hook and loop materials, in order to be refastenable. However, U.S. Pat. No. 5,779,831 does not describe or illustrate how such mechanical fastening materials can be incorporated into the undergarments.

Application of fastening materials to a nonwoven web in order to form absorbent garments having refastenable side seams is not easily accomplished. Disposable absorbent garments present many manufacturing challenges. In part, this is due to the high speed that is necessary to economically produce relatively low cost disposable absorbent garments. Further, prefastened and refastenable garments present new challenges for high speed manufacturing. Such products must be folded in a manner that allows the refastenable fasteners to be properly aligned and engaged. Improperly attached or aligned fasteners can lead to many product deficiencies, including machine waste and/or delay, improper fit, fastener delamination during use, fastener disengagement during use, skin irritation, or the like. Further, handling a nonwoven web with “free” fastening surfaces is very difficult because the fastening surfaces can potentially engage into any portion of the web—whether it is a “mating” portion or not. The handling and control of “free” fastening surfaces is further complicated when the web has already been cut into individual garments.

Thus, what is lacking and needed in the art is a process for applying fastening materials to a nonwoven web and bringing the fastening materials into aligned contact with each other to form a product seam. Further, a process is needed that maintains control over the fastening materials before they are brought into contact with each other. The process needs to be suitable for use with discrete articles including mechanical fastening components and suitable for the manufacture of prefastened and refastenable pants.

### SUMMARY OF THE INVENTION

In response to the above-referenced unfulfilled need in the art, new methods for preconditioning a web of material to form a refastenable undergarment have been discovered. The present invention is directed to a method of making an undergarment having refastenable side seams from a substantially two-dimensional web. The two-dimensional web can include woven and non-woven materials typically used to construct disposable absorbent garments such as a liquid impermeable outer cover, an absorbent core and a liquid permeable liner that contacts the skin in use. The two-dimensional web has two longitudinal sides and a first lateral edge that extends generally perpendicularly to the longitudinal sides.

In one aspect, the method of the invention includes a step of preconditioning the web to include at least four refastening surfaces. The method of the invention contemplates that the refastenable undergarment will have at least two side seams and that at least two refastening surfaces will be necessary to form each side seam. However, it is also possible for the undergarment to have one refastenable side seam and one seam that is not refastenable (ultrasonically bonded or other attachment). The refastening surfaces can be formed from a variety of materials that can be fastened to each other. The methods of the invention are not restricted with respect to the mechanisms by which the refastenable surfaces fasten to each other. Desirably, when in use on a disposable undergarment, the refastenable surfaces can be separated from each other and conveniently re-attached to each other. Examples of refastenable surfaces include hook material and mating loop material. In addition to mechanical engagement, the refastenable surfaces can also engage each other by chemical, magnetic, adhesive, cohesive or other mechanisms of engagement.

“Preconditioning” of the web includes the incorporation or application of the refastening surfaces into or onto the web. The web materials themselves can be conditioned to form a refastening surface; for example, portions of the liner or outer cover can be configured to provide refastening surfaces. Typically, disposable absorbent garments are made from various nonwoven materials. Nonwoven materials can be selected to be engageable with hook material and other mechanical fasteners and therefore, to be refastening surfaces. Additionally, separate refastening materials can be applied onto the web; for example, hook material and other mechanical fastening materials can be adhered or bonded to the web. The web can be preconditioned to include more than one type of refastening surface. For example, it may be desirable to have one type of refastening surface on the portion of the web that will eventually become the front waist section of the garment and another type of refastening surface on the portion of the web that will eventually become the back waist section. Specifically, it may be desirable to apply a hook material to the portion of the web that will form back waist sections and to apply a loop material to the portion of the web that will form front waist sections. The result using the methods of the invention will be that the hook and loop material surfaces will be brought into contact with each other and joined to form refastenable seams on the undergarments formed from the web.

The methods of the invention also include a step of transporting the web in a processing direction. The web can be transported in the processing direction using a variety of techniques including conveyor or other mechanical displacement, vacuum and fluid transport. The processing direction is selected to advance the web toward handling by desired pieces of manufacturing equipment and to ultimately produce individual undergarments. Typically, when nonwoven webs are used to manufacture disposable absorbent undergarments, the undergarments can be formed in either the “machine” direction or the “cross” direction. “Machine” direction manufacture is understood to mean that the length or longitudinal direction of the undergarment is formed in the same direction that the web moves during production. “Cross” direction manufacture is understood to mean that the length or longitudinal direction of the undergarment is formed in a direction that is generally perpendicular to the direction that the web moves during production.

The methods of the invention include cutting the web along a second lateral edge to form a two-dimensional pre-form. The pre-form includes the first and second lateral edges and the two longitudinal edges. When pre-forms are translated into machine direction undergarments, each longitudinal edge of the pre-form has two waist sections and a crotch section located intermediate the waist sections. When pre-forms are translated into cross direction undergarments, each lateral edge of the pre-form has two waist sections and a crotch section located intermediate the waist sections. For both machine direction and cross direction pre-forms, the refastening surfaces are located adjacent and laterally inboard (from the side edges) on the waist sections.

Alternatively, to capture that the methods of the invention can be used to manufacture both machine direction and cross direction undergarments, the web can have two lateral sides and a first longitudinal edge that extends generally perpendicularly to the lateral sides. When the web is cut, it is cut along a second longitudinal edge to form a two-dimensional pre-form. The pre-form includes the first and the second longitudinal edges and the two lateral edges. Each of the longitudinal edges includes two waist sections and a crotch section located intermediate the waist sections. As with the methods of the invention where the web is cut along a second lateral edge, the refastening surfaces are located adjacent and inboard on the waist sections.

The web can be cut using conventional techniques such as flex knife, shear knife, hot knife, laser, water, crushing and ultrasonics. In addition to the lateral and longitudinal edges, the pre-forms can include an exterior surface and a body-contacting surface opposite the exterior surface. When the undergarments are in use, the exterior surface faces away from the wearer and is usually in contact with the wearer's clothes. The body-contacting surface is then that surface of the undergarment that comes into contact with the wearer's skin. The waist sections of the pre-form can define a front waist section and a back waist section. Typically, the front waist section forms the portion of the completed undergarment that is worn forward in use and the back waist section forms the portion that provides coverage of the wearer's buttocks.

Having defined the pre-form to have exterior and body-contacting surfaces and front and back waist sections, various configurations for preconditioning the web to have at least four refastening surfaces can be described. For example, two of the refastening surfaces can be located on the exterior surface of the front waist section and two of the refastening surfaces can be located on the body-contacting surface of the back waist section. With this type of configuration, the refastenable side seams are formed by overlapping the refastening surfaces on the front and back waist sections (a.k.a. a “lap” seam). In another example, two of the refastening surfaces are located on the body-contacting surface of the front waist section and two of the refastening surfaces are located on the exterior surface of the back waist section.

The web can also be preconditioned to include refastening surfaces configured so that the refastenable side seams are formed by an abutting, or “butt”, type of seam. In this case, two of the refastening surfaces are located on the body-contacting surface of the front waist section and two of the refastening surfaces are located on the body-contacting surface of the back waist section. When the refastening surfaces are brought into contact with each other and joined, the butt-type seam can be folded inward toward the exterior surface of the pre-form and bonded down to the exterior surface of the pre-form. The seam can be bonded down by suitable known techniques including thermal, adhesive and ultrasonic bonding.

With the methods of the invention, the web can be preconditioned to include the refastening surfaces in such a way that the portions of the web that will form pre-forms are aligned back waist to back waist or, alternatively, back waist to front waist. That is to say, prior to cutting of the web, there are portions of the web that will form adjacent pre-forms and the adjacent pre-forms are joined to each other by the back waist section of one pre-form and the back waist section of the adjacent pre-form. Alternatively, there are portions of the web that will form adjacent pre-forms and the adjacent pre-forms are joined to each other by the back waist section of one pre-form and front waist section of the adjacent pre-form.

After the web is cut, the methods of the invention include a step of gripping the pre-form adjacent each waist section with a gripping means in four gripping areas. Each gripping area is associated with or located near a respective refastening surface. Next, at least the gripping means, which hold the gripping areas in the region of one of the lateral edges, are jointly rotated around at least one hinging axis. The hinging axis extends substantially parallel to the lateral edges of the pre-form. Joint rotation of the gripping means places the first lateral edge generally parallel and opposite to the second lateral edge. After the gripping means are jointly rotated, the refastening surfaces are superimposed in a contacting relationship. The superimposed refastening surfaces are then joined in a securing means in order to form an individual undergarment. The individual undergarment is then released from the gripping means.

When two of the refastening surfaces are located on the exterior surface of the front waist section and two of the refastening surfaces are located on the body-facing surface of the back waist region, the methods of the invention can further include a step of folding a portion of the longitudinal edge of the front waist section inward. Such a folding inward can facilitate joining of the superimposed refastening surfaces. The folding inward can be done prior to joint rotation of the gripping means.

In another aspect, the methods of the invention can include preconditioning the web to include at least two areas of hook material and two areas of a mating loop material. Combinations of hook and loop materials are used on a variety of disposable absorbent articles to provide closure of the articles about a wearer. Suitable hook and loop materials are well known and are described in more detail herein. After the web is cut, the areas of hook material and areas of mating loop material are located adjacent and inboard on the waist sections of the pre-form. When the pre-form is gripped adjacent each waist section, two of the gripping areas are generally located near respective areas of hook material and two of the gripping areas are generally located near respective areas of mating loop material. After gripping means are jointly rotated, the areas of hook material are superimposed with the areas of mating loop material in a contacting relationship. The superimposed areas of hook material and areas of mating loop material are joined in a securing means to form individual undergarments.

With aspects of the invention using hook and loop materials, various alternative configurations of the hook and loop materials can be selected. For example, the areas of mating loop material can be located on the exterior surface of the front waist section of the pre-form and the areas of hook material can be located on the body-contacting surface of the back waist section. In another configuration, the areas of hook material can be located on the exterior surface of the front waist section and the areas of mating loop material can be located on the body-contacting surface of the back waist section. These two configurations can be reversed—that is, the location of the hook and loop materials can be reversed from the exterior surfaces to the body-contacting surfaces: (1) mating loop material on the body-contacting surface of the front waist section and hook material on the exterior surface of the back waist section; and (2) hook material on the body-contacting surface of the front waist section and mating loop material on the exterior surface of the back waist region. These types of configurations can be used to form undergarments with refastenable lap-type side seams.

Hook and loop materials can also be used to form undergarments having refastenable butt-type side seams. In an exemplary configuration, the areas of hook material can be located on the body-contacting surface of the front waist section and the areas of mating loop material can be located on the body-contacting surface of the back waist section. Alternatively, the areas of mating loop material can be located on the body-contacting surface of the front waist section and the areas of hook material can be located on the body-contacting surface of the back waist section. In another configuration, the areas of hook material and the areas of mating loop material are located on the exterior surface of the front and back waist sections to form an inward (toward the body of the wearer) pointing butt-type seam. With the “outward” facing butt-type seam aspects, it may be desirable to also fold the joined, superimposed refastening surfaces inward toward the exterior surface of the pre-form and to bond the joined refastening surfaces to the exterior surface of the pre-form. Such folding and bonding can result in a seam that is a combination or hybrid of a lap-type seam and a butt-type seam.

The methods of the invention provide an operative mechanism for integrating refastenable surfaces, such as hook and loop material fasteners, into a continuous web prior to the web being cut and folded into individual undergarments. The approach of the invention minimizes the difficulty associated with superimposing and joining the refastenable surfaces. It is believed that the refastenable surfaces need to be integral with or incorporated into the web prior to the web being cut into individual pre-forms. Application of refastenable surfaces after cutting the web into individual pre-forms would increase the risk of the refastenable surfaces prematurely engaging each other or other undesired portions of the pre-form.

It is to be understood that both the foregoing general description and the following detailed description are exemplary and are intended to provide further explanation of the invention claimed. The accompanying drawings, that are incorporated in and constitute part of this specification, are included to illustrate and provide a further understanding of the methods of the invention. Together with the description, the drawings serve to explain various aspects of the invention.

### BRIEF DESCRIPTION OF THE DRAWINGS

The present invention will be more fully understood and further advantages will become apparent when reference is made to the following detailed description of the invention and the accompanying drawings wherein like numerals represent like elements. The drawings are merely representative and are not intended to limit the scope of the appended claims.

FIGS. 1 and 2 show embodiments of an undergarment having overlapping and butt-type side seams, respectively. FIGS. 1A and 2A show close-ups of the overlapping and butt-type seams.

FIG. 3 shows a side view of a refastenable undergarment with the refastenable side seams open to expose two of the refastening surfaces.

FIG. 4 shows a top plan view of a two-dimensional pre-form for forming an undergarment having refastenable side seams and showing the surface of the undergarment that faces the wearer when the undergarment is worn, and with portions cut away to show the underlying features.

FIG. 5 shows a schematic side elevational view of a folding-and-sealing unit according to the invention in the gripping position.

FIG. 6 shows a top elevational view of the apparatus of FIG. 5.

FIGS. 7 and 8 show a side elevational view of the apparatus of FIG. 5 in the sealing position.

FIG. 9 shows a schematic front elevational view of the apparatus as shown in FIG. 8.

FIG. 10 shows a schematic side elevational view of an embodiment of the apparatus according to the invention in an alternative sealing position.

FIG. 11 shows a schematic side elevational view of an embodiment of an umbrella-type apparatus for forming side seams.

FIG. 12 shows a cross-sectional view of an umbrella-type apparatus for forming side seams in the gripping position.

FIG. 13 shows a cross-sectional view of an umbrella-type apparatus for forming side seams in the sealing position.

FIGS. 14-17 show schematic side elevational views of the gripping and sealing phases of motion of an umbrella-type apparatus.

FIG. 18 shows a top cross-sectional view of the umbrella-type apparatus of FIGS. 12 and 13.

FIGS. 19 and 20 show a schematic top plan view of a web from which the pre-forms are cut in a machine and in a cross direction, respectively.

FIG. 21 shows a schematic top view of the gripping and sealing means on formation of a butt-type side seam.

FIG. 22 shows a schematic top view of the gripping and sealing means on formation of a combined overlapping and butt-type side seam.

FIG. 23 shows a schematic top view of the gripping and sealing means on formation of a three-layer overlapping side seam.

FIGS. 24-28 show various approaches to preconditioning the web.

FIG. 29 shows folding over of a butt-type seam formed into an undergarment made by a method of the invention. And,

FIG. 30 shows folding over of an edge of a pre-form in order to form a lap-type seam into an undergarment made by a method of the invention.

### DETAILED DESCRIPTION OF THE INVENTION

The methods of the present invention can be used to make a variety of undergarments having refastenable side seams. Examples of such garments include disposable absorbent articles such as diapers, training pants, feminine hygiene products, incontinence products, other personal care or health care garments; swim pants; athletic clothing; pants, bibs and shorts; and similar types of garments. For ease of explanation, the description hereafter will be in terms of methods for making a child's toilet-training pant. In particular, the methods will be described in terms of those for making prefastened and refastenable disposable training pants as described in U.S. patent application Ser. No. 09/444,083 titled “Absorbent Articles With Refastenable Side Seams” and filed Nov. 22, 1999 (corresponding to PCT application WO 00/37009 published Jun. 29, 2000) by A. L. Fletcher et al., the disclosure of which is incorporated herein by reference.

The present disclosure of the invention will be expressed in terms of its various components, elements, constructions, configurations, arrangements and other features that may also be individually or collectively be referenced by the term, “aspect(s)” of the invention, or other similar terms. It is contemplated that the various forms of the disclosed invention may incorporate one or more of its various features and aspects, and that such features and aspects may be employed in any desired, operative combination thereof.

It should also be noted that, when employed in the present disclosure, the terms “comprises”, “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

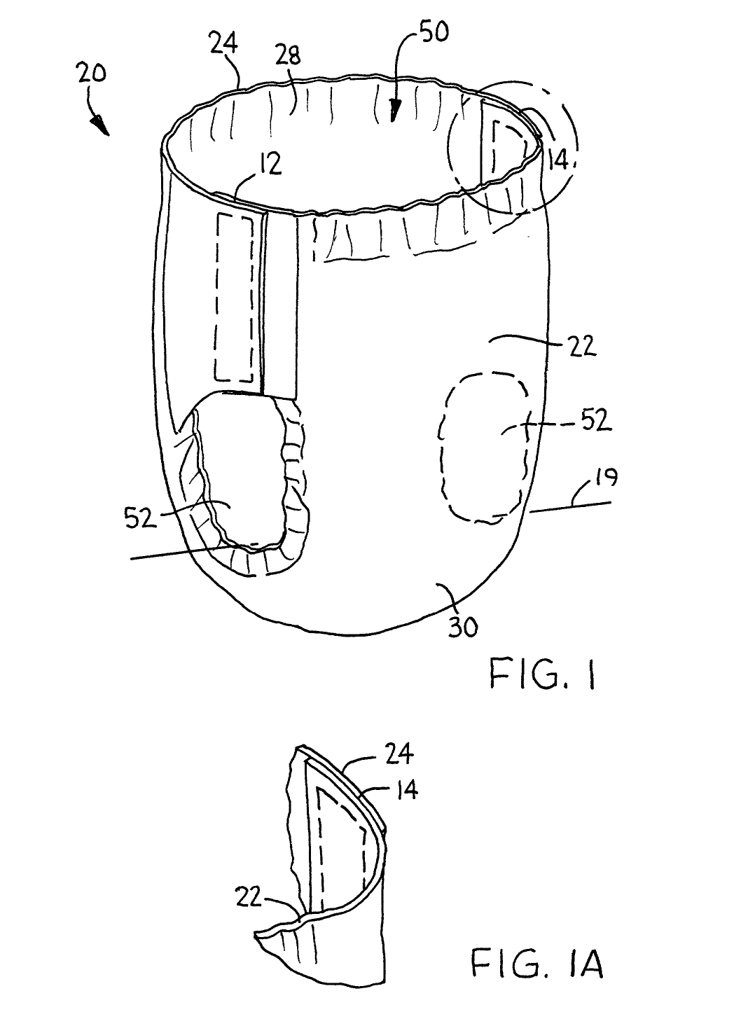

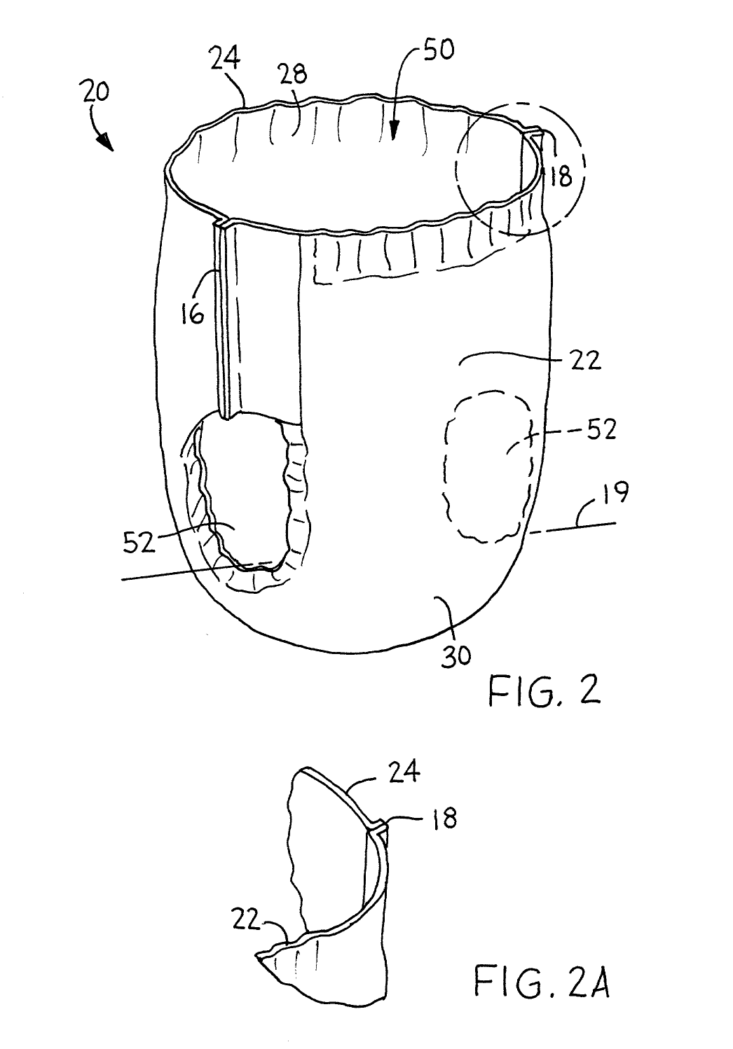

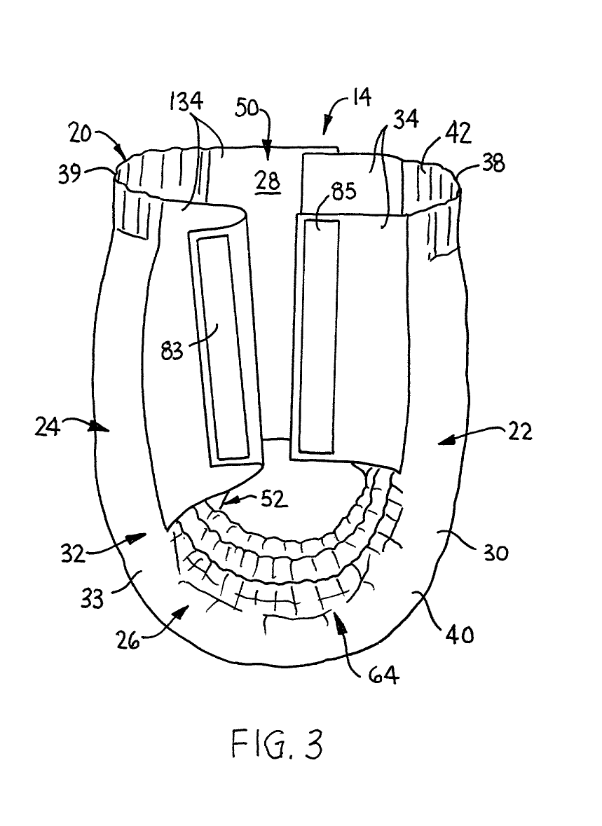

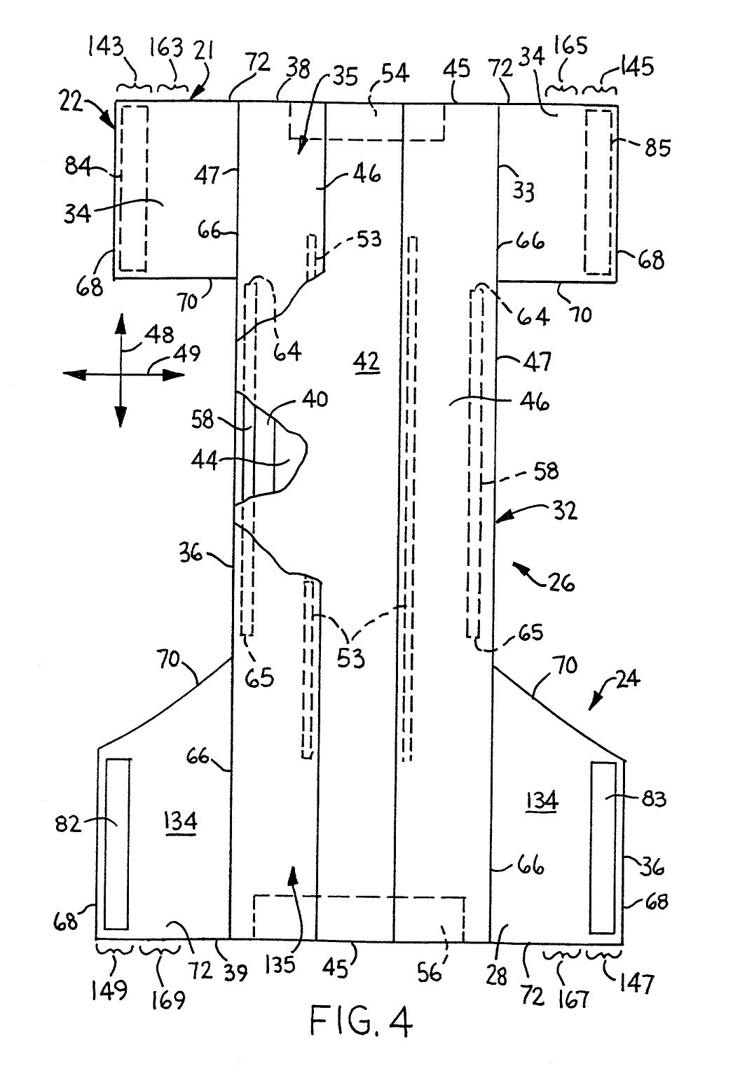

FIGS. 1 and 3 representatively illustrate a training pant 20 made by a method of the invention and having overlapping side seams 12 and 14. FIG. 2 representatively illustrates a training pant 20 made by a method of the invention and having abutting, or butt, side seams 16 and 18. The training pant 20 includes an absorbent chassis 32 and the absorbent chassis 32 defines a front waist section 22, a back waist section 24 and a crotch or interconnecting section 26 interconnecting the front and back waist sections. The absorbent chassis 32 also includes a body-contacting surface 28 that is configured to contact the wearer, and an exterior surface 30 opposite the body-contacting surface 28 that is configured to contact the wearer's clothing. A two-dimensional pre-form 21 that is formed into a training pant 20 is illustrated in FIG. 4. With reference to FIG. 4, the absorbent chassis 32 also defines a pair of transversely opposed side edges 36 and a pair of longitudinally opposed waist edges, which are designated front waist edge 38 and back waist edge 39. The front waist section 22 is contiguous with the front waist edge 38, and the back waist section 24 is contiguous with the back waist edge 39.

The illustrated absorbent chassis 32 includes a composite structure 33 that can be rectangular or any other desired shape, a pair of transversely opposed front side panels 34 and a pair of transversely opposed back side panels 134. The front and back side panels 34 and 134 each include a refastening surface 82, 83, 84 & 85. The composite structure 33 and side panels 34 and 134 may include two or more separate elements, as shown in FIG. 3, or be integrally formed. Integrally formed side panels and composite structure would include at least some common materials, such as the liquid pervious topsheet, flap composite, liquid-impervious backsheet, other materials and/or combinations thereof, and could define a one-piece elastic, stretchable, or non-stretchable pant. The illustrated composite structure 33 includes a liquid-impervious backsheet 40, liquid pervious topsheet 42 (FIGS. 3 and 4) that is connected to the backsheet 40 in a superposed relation, an absorbent core 44 (FIG. 4) that is located between the backsheet 40 and the topsheet 42, and a pair of containment flaps 46 (FIG. 4). The illustrated composite structure 33 has opposite longitudinal end edges 45 that form portions of the front and back waist edges 38 and 39, and opposite lateral side edges 47 that form portions of the side edges 36 of the absorbent chassis 32 (FIG. 4). With adult incontinence garments, the composite structure 33 does not necessarily extend so far as to form portions of the front and back waist edges 38 and 39. Further, the front side panel 34 and front center panel 35 can be one continuous piece of material in an adult incontinence pant. For reference, arrows 48 and 49 depicting the orientation of the longitudinal axis and the lateral axis, respectively, of the two-dimensional pre-form 21 that will form the training pant 20 are illustrated in FIG. 4.

With the training pant 20 in the fastened position as illustrated in FIGS. 1 and 2, the front and back waist regions 22 and 24 are joined together to define a three-dimensional pant configuration having a waist opening 50 and a pair of leg openings 52. The front waist section 22 includes the portion of the training pant 20 which, when worn, is positioned on the front of the wearer while the back waist section 24 includes the portion of the training pant which, when worn, is positioned on the back of the wearer. The crotch section 26 of the training pant 20 includes the portion of the training pant which, when worn, is positioned between the legs of the wearer and covers the lower torso of the wearer. The front and back side panels 34 and 134 include the portions of the training pant 20 which, when worn, are positioned on the hips of the wearer.

The front waist region 22 of the absorbent chassis 32 includes the laterally opposed front side panels 34 and a front center panel 35 (FIG. 4) positioned between and interconnecting the side panels. The back waist section 24 of the absorbent chassis 32 includes the laterally opposed back side panels 134 and a back center panel 135 (FIG. 4) positioned between and interconnecting the side panels. The waist edges 38 and 39 of the absorbent chassis 32 are configured to encircle the waist of the wearer when worn and provide the waist opening 50 that defines a waist perimeter dimension. Portions of the longitudinally opposed side edges 36 in the crotch section 26 generally define the leg openings 52.

The absorbent chassis 32 is configured to contain and/or absorb any body exudates discharged from the wearer. For example, the absorbent chassis 32 desirably although not necessarily includes the pair of containment flaps 46 that are configured to provide a barrier to the lateral flow of body exudates. A flap elastic member 53 (FIG. 4) can be operatively joined with each containment flap 46 in any suitable manner as is well known in the art. The elasticized containment flaps 46 define an unattached edge that assumes an upright configuration in at least the crotch region 26 of the training pant 20 to form a seal against the wearer's body. The containment flaps 46 can be located along the longitudinally opposed side edges of the absorbent chassis 32, and can extend longitudinally along the entire length of the absorbent chassis or may only extend partially along the length of the absorbent chassis. Suitable constructions and arrangements for the containment flaps 46 are generally well known to those skilled in the art and are described in U.S. Pat. No. 4,704,116 issued Nov. 3, 1987 to Enloe, which is incorporated herein by reference.

To further enhance containment and/or absorption of body exudates, the training pant 20 desirably although not necessarily includes a front waist elastic member 54, a back waist elastic member 56, and leg elastic members 58, as are known to those skilled in the art (FIG. 4). The waist elastic members 54 and 56 can be operatively joined to the backsheet 40 and/or topsheet 42 along the opposite waist edges 38 and 39, and can extend over part or all of the waist edges. The leg elastic members 58 can be operatively joined to the backsheet 40 and/or topsheet 42 along the opposite side edges 36 and positioned in the crotch region 26 of the training pant 20. The leg elastic members 58 can be longitudinally aligned along each side edge 47 of the composite structure 33. Each leg elastic member 58 has a front terminal point 64 and a back terminal point 65, which points represent the longitudinal ends of the elastic gathering caused by the leg elastic members 58. The front terminal points 64 can be located adjacent the longitudinally innermost parts of the front side panels 34, and the back terminal points 65 can be located adjacent the longitudinally innermost parts of the back side panels 134.

The flap elastic members 53, the waist elastic members 54 and 56, and the leg elastic members 58 can be formed of any suitable elastic material. As is well known to those skilled in the art, suitable elastic materials include sheets, strands or ribbons of natural rubber, synthetic rubber, or thermoplastic elastomeric polymers. The elastic materials can be stretched and adhered to a substrate, adhered to a gathered substrate, or adhered to a substrate and then elasticized or shrunk, for example with the application of heat; such that elastic constrictive forces are imparted to the substrate. In one particular embodiment, for example, the leg elastic members 58 comprise a plurality of dry-spun coalesced multifilament spandex elastomeric threads sold under the trade name LYCRA® and available from E. I. Du Pont de Nemours and Company, Wilmington, Del. U.S.A.

The liquid-impervious backsheet 40 desirably includes a material that is substantially liquid impermeable, and can be elastic, stretchable or nonstretchable. The backsheet 40 can be a single layer of liquid impermeable material, but desirably includes a multi-layered laminate structure in which at least one of the layers is liquid impermeable. For instance, the backsheet 40 can include a liquid permeable outer layer and a liquid impermeable inner layer that are suitably joined together by a laminate adhesive, ultrasonic bonds, thermal bonds, or the like. Suitable laminate adhesives, which can be applied continuously or intermittently as beads, a spray, parallel swirls, or the like, can be obtained from Bostik-Findley, Inc., of Wauwatosa, Wis. U.S.A., or from National Starch and Chemical Company, Bridgewater, N.J. U.S.A. The liquid permeable outer layer can be any suitable material and desirably one that provides a generally cloth-like texture. One example of such a material is a 20 gsm (grams per square meter) spunbond polypropylene nonwoven web. The outer layer may also be made of those materials of which liquid-permeable topsheet 42 is made. While it is not a necessity for outer layer to be liquid permeable, it is desired that it provides a relatively cloth-like texture to the wearer.

The inner layer of the backsheet 40 can be both liquid and vapor impermeable, or can be liquid impermeable and vapor permeable. The inner layer can be manufactured from a thin plastic film, although other flexible liquid impermeable materials may also be used. The inner layer, or the liquid-impermeable backsheet 40 when a single layer, prevents waste material from wetting articles, such as bedsheets and clothing, as well as the wearer and caregiver. A suitable liquid impermeable film for use as a liquid impermeable inner layer, or a single layer liquid impermeable backsheet 40, is a 0.02 millimeter polyethylene film commercially available from Pliant Corporation of Newport News, Va. U.S.A. If the backsheet 40 is a single layer of material, it can be embossed and/or matte finished to provide a more cloth-like appearance. As earlier mentioned, the liquid impermeable material can permit vapors to escape from the interior of the undergarment, while still preventing liquids from passing through the backsheet 40. A suitable “breathable” material is composed of a microporous polymer film or a nonwoven fabric that has been coated or otherwise treated to impart a desired level of liquid impermeability. A suitable microporous film is a PMP-1 film material commercially available from Mitsui Toatsu Chemicals, Inc., Tokyo, Japan, or an XKO-8044 polyolefin film commercially available from 3M Company, Minneapolis, Minn. U.S.A.

The training pant 20 and in particular the backsheet 40 desirably includes one or more appearance-related components. Examples of appearance-related components include, but are not limited to, graphics; highlighting or emphasizing leg and waist openings in order to make product shaping more evident or visible to the user; highlighting or emphasizing areas of the product to simulate functional components such as elastic leg bands, elastic waistbands, simulated “fly openings” for boys, ruffles for girls; highlighting areas of the product to change the appearance of the size of the product; registering wetness indicators, temperature indicators, and the like in the product; registering a back label, or a front label, in the product; and registering written instructions at a desired location in the product. Any suitable design can be utilized for a training pant 20 so as to be aesthetically and/or functionally pleasing to the wearer and the caregiver. The appearance-related components are desirably positioned on the training pant 20 at selected locations, which can be carried out using the methods disclosed in U.S. Pat. No. 5,766,389 issued Jun. 16, 1998 to Brandon et al., which is incorporated herein by reference.

The liquid-permeable topsheet 42 is illustrated as overlying the backsheet 40 and absorbent core 44, and may but need not have the same dimensions as the backsheet 40. The topsheet 42 is desirably compliant, soft feeling, and non-irritating to the child's skin. Further, the topsheet 42 can be less hydrophilic than the absorbent core 44, to present a relatively dry surface to the wearer and permit liquid to readily penetrate through its thickness. Alternatively, the topsheet 42 can be more hydrophilic or can have essentially the same affinity for moisture as the absorbent core 44 to present a relatively wet surface to the wearer to increase the sensation of being wet. This wet sensation can be useful as a training aid. The hydrophilic/hydrophobic properties can be varied across the length, width and depth of the topsheet 42 and absorbent core 44 to achieve the desired wetness sensation or leakage performance.

The topsheet 42 can be manufactured from a wide selection of web materials, such as synthetic fibers (for example, polyester or polypropylene fibers), natural fibers (for example, wood or cotton fibers), a combination of natural and synthetic fibers, porous foams, reticulated foams, apertured plastic films, or the like. Various woven and nonwoven fabrics can be used for the topsheet 42. For example, the topsheet 42 can be composed of a meltblown or spunbonded web of polyolefin fibers. The topsheet 42 can also be a bonded-carded web composed of natural and/or synthetic fibers. The topsheet 42 can be composed of a substantially hydrophobic material, and the hydrophobic material can, optionally, be treated with a surfactant or otherwise processed to impart a desired level of wettability and hydrophilicity. For example, the material can be surface treated with about 0.45 weight percent of a surfactant mixture comprising Ahcovel N-62 from Hodgson Textile Chemicals of Mount Holly, N.C. U.S.A. and Glucopan 220UP from Henkel Corporation of Ambler, Pa. in an active ratio of 3:1. The surfactant can be applied by any conventional technique, such as spraying, printing, brush coating, dipping or other similar techniques. The surfactant can be applied to the entire topsheet 42 or can be selectively applied to particular sections of the topsheet 42, such as the medial section along the longitudinal center line.

A suitable liquid-permeable topsheet 42 is a nonwoven bicomponent web having a basis weight of about 27 gsm. The nonwoven bicomponent can be a spunbond bicomponent web, or a bonded carded bicomponent web. Suitable bicomponent staple fibers include a polyethylene/polypropylene bicomponent fiber available from CHISSO Corporation, Osaka, Japan. In this particular bicomponent fiber, the polypropylene forms the core and the polyethylene forms the sheath of the fiber. Other fiber orientations are possible, such as multi-lobe, side-by-side, end-to-end, or the like. The backsheet 40, topsheet 42 and other materials used to construct the pant can comprise elastomeric or nonelastomeric materials.

The absorbent core 44 (FIG. 4) is positioned between the backsheet 40 and the topsheet 42, which components can be joined together by any suitable technique such as adhesives, ultrasonic bonds, thermal bonds or similar techniques. The absorbent core 44 can be any structure that is generally compressible, conformable, non-irritating to the child's skin, and capable of absorbing and retaining liquids and certain body wastes. The absorbent assembly 44 can be manufactured in a wide variety of sizes and shapes, and from a wide variety of liquid absorbent materials commonly used in the art. For example, the absorbent core 44 can suitably include a matrix of hydrophilic fibers, such as a web of cellulosic fluff, mixed with particles of a high-absorbency material commonly known as superabsorbent material. In a particular embodiment, the absorbent core 44 includes a matrix of cellulosic fluff, such as wood pulp fluff, and superabsorbent hydrogel-forming particles. The wood pulp fluff can be exchanged with synthetic, polymeric, meltblown fibers or short cut homofill bicomponent synthetic fibers and natural fibers. The superabsorbent particles can be substantially homogeneously mixed with the hydrophilic fibers or can be nonuniformly mixed. The fluff and superabsorbent particles can also be selectively placed into desired zones of the absorbent assembly 44 to better contain and absorb body exudates. The concentration of the superabsorbent particles can also vary through the thickness of the absorbent core 44. Alternatively, the absorbent core 44 can comprise a laminate of fibrous webs and superabsorbent material or other suitable technique of maintaining a superabsorbent material in a localized area.

Suitable superabsorbent materials can be selected from natural, synthetic, and modified natural polymers and materials. The superabsorbent materials can be inorganic materials, such as silica gels, or organic compounds, such as crosslinked polymers, for example, sodium neutralized polyacrylic acid. Suitable superabsorbent materials are available from various commercial vendors, such as Dow Chemical Company located in Midland, Mich. U.S.A., and Stockhausen GmbH & Co. KG, D-47805 Krefeld, Federal Republic of Germany. Typically, a superabsorbent material is capable of absorbing at least about 15 times its weight in water, and desirably is capable of absorbing more than about 25 times its weight in water.

In one embodiment, the absorbent assembly 44 which can be rectangular or any other desired shape comprises a blend of wood pulp fluff and superabsorbent material. One preferred type of pulp is identified with the trade designation CR1654, available from U.S. Alliance, Childersburg, Ala. U.S.A., and is a bleached, highly absorbent sulfate wood pulp containing primarily soft wood fibers and about 16 percent hardwood fibers. As a general rule, the superabsorbent material is present in the absorbent core 44 in an amount of from 0 to about 90 weight percent based on total weight of the absorbent core 44. The absorbent core 44 suitably has a density within the range of about 0.10 to about 0.35 grams per cubic centimeter. The absorbent core 44 may or may not be wrapped or encompassed by a suitable tissue wrap that may help maintain the integrity and/or shape of the absorbent assembly. The absorbent assembly may be a single homogenous layer or it may contain areas having a higher concentration of superabsorbent material. The absorbent assembly may also contain multiple layers to aid in the acquisition and distribution of fluids.

The absorbent chassis 32 can also incorporate other materials that are designed primarily to receive, temporarily store, and/or transport liquid along the mutually facing surface with absorbent core 44, thereby maximizing the absorbent capacity of the absorbent assembly. One suitable material is referred to as a surge layer (not shown) and includes a material having a basis weight of about 50 to about 120 grams per square meter. The material includes a through-air-bonded-carded web of a homogenous blend of 60 percent 3 denier type T-256 bicomponent fiber including a polyester core/polyethylene sheath and 40 percent 6 denier type T-295 polyester fiber, both commercially available from KoSa Corporation of Salisbury, N.C. U.S.A.

As noted previously, the illustrated training pant 20 has front and back side panels 34 and 134 disposed on each side of the absorbent chassis 32. These transversely opposed front side panels 34 and transversely opposed back side panels 134 can be permanently bonded along attachment lines 66 to the composite structure 33 of the absorbent chassis 32 in the respective front and back waist sections 22 and 24. More particularly, as shown best in FIGS. 3 and 4, the front side panels 34 can be permanently bonded to and extend transversely beyond the linear side edges 47 of the composite structure 33 in the front waist section 22, and the back side panels 134 can be permanently bonded to and extend transversely beyond the linear side edges of the composite structure in the back waist section 24. Alternatively, the front and back side panels 34 and 134 can be laterally continuous in the front waist section 22 and the back waist section 24 and extend in the longitudinal direction 48 beyond the composite structure 33 of the absorbent chassis 32. The side panels 34 and 134 may be attached using attachment means known to those skilled in the art such as adhesive, thermal or ultrasonic bonding. Alternatively, the side panels 34 and 134 can be formed as an integral portion of a component of the composite structure 33. For example, the side panels can include a generally wider portion of the outer cover, the bodyside liner, and/or another component of the absorbent chassis. The front and back side panels 34 and 134 are desirably releasably attached to one another. Alternatively, the front and back side panels 34 and 134 can be permanently bonded to each other (at the side seams 12 and 14) and can be releasably bonded to the composite structure 33 of the absorbent chassis 32.

The illustrated side panels 34 and 134 each define a distal edge 68 that is spaced from the attachment line 66, a leg end edge 70 disposed toward the longitudinal center of the training pant 20, and a waist end edge 72 disposed toward a longitudinal end of the pre-form 21. The leg end edge 70 and waist end edge 72 extend from the side edges 47 of the composite structure 33 to the distal edges 68. The leg end edges 70 of the side panels 34 and 134 form part of the side edges 36 of the absorbent chassis 32. In the back waist section 24, the leg end edges 70 are desirably although not necessarily curved and/or angled relative to the lateral axis 49 to provide greater coverage toward the back of the pant as compared to the front of the pant. The waist end edges 72 are desirably parallel to the lateral axis 49. The waist end edges 72 of the front side panels 34 form part of the front waist edge 38 of the absorbent chassis 32, and the waist end edges 72 of the back side panels 134 form part of the back waist edge 39 of the absorbent chassis.

In particular embodiments for improved fit and appearance, the side panels 34 and 134 desirably have an average length dimension measured parallel to the longitudinal axis 48 that is about 20 percent or greater, and particularly about 25 percent or greater, of the overall length dimension of the absorbent article, also measured parallel to the longitudinal axis 48. For example, in training pants having an overall length dimension of about 54 centimeters, the side panels 34 and 134 desirably have an average length dimension of about 10 centimeters or greater, such as about 15 centimeters. While each of the side panels 34 and 134 extend from the waist opening 50 to one of the leg openings 52, the illustrated back side panels 134 have a continually decreasing length dimension moving from the attachment line 66 to the distal edge 68, as is best shown in FIG. 4.

Each of the side panels 34 and 134 can include one or more individual, distinct pieces of material. In particular embodiments, for example, each side panel 34 and 134 can include first and second side panel portions that are joined at a seam, or can include a single piece of material that is folded over upon itself (not shown).

The side panels 34 and 134 desirably although not necessarily include an elastic material capable of stretching in a direction generally parallel to the lateral axis 49 of the training pant 20. Suitable elastic materials, as well as one process of incorporating elastic side panels into a training pant, are described in the following U.S. Pat. No. 4,940,464 issued Jul. 10, 1990 to Van Gompel et al.; U.S. Pat. No. 5,224,405 issued Jul. 6, 1993 to Pohjola; U.S. Pat. No. 5,104,116 issued Apr. 14, 1992 to Pohjola; and U.S. Pat. No. 5,046,272 issued Sep. 10, 1991 to Vogt et al.; all of which are incorporated herein by reference. In particular embodiments, the elastic material includes a stretch-thermal laminate (STL), a neck-bonded laminate (NBL), a reversibly necked laminate, or a stretch-bonded laminate (SBL) material. Methods of making such materials are well known to those skilled in the art and described in U.S. Pat. No. 4,663,220 issued May 5, 1987 to Wisneski et al.; U.S. Pat. No. 5,226,992 issued Jul. 13, 1993 to Morman; and European Patent Application No. EP 0 217 032 published on Apr. 8, 1987 in the names of Taylor et al.; all of which are incorporated herein by reference. Alternatively, the side panel material may include other woven or nonwoven materials, such as those described above as being suitable for the backsheet 40 or topsheet 42; mechanically pre-strained composites; or stretchable but inelastic materials. Alternatively, the side panels 34 and 134 can include layers of woven or nonwoven fabric with strands of elastic (such as LYCRA elastic material) bonded between. Additionally, the side panels 34 and 134 can include woven or nonwoven materials bonded to a breathable film or laminate with strands of elastic bonded in between.

The illustrated training pant 20 includes a fastening system for refastenably securing the training pant about the waist of the wearer. The illustrated fastening system includes first refastening surfaces 82 and 83 that are adapted to refastenably connect to mating second refastening surfaces 84 and 85. In one embodiment, one surface of each of the first refastening surfaces 82 and 83 includes a plurality of engaging elements that project from that surface. The engaging elements of the first refastening surfaces 82 and 83 are adapted to repeatedly engage and disengage engaging elements of the second refastening surfaces 84 and 85.

In one particular embodiment, the first refastening surfaces 82 and 83 each include hook type fasteners and the second refastening surfaces 84 and 85 each include complementary loop type fasteners. In another particular embodiment, the first refastening surfaces 82 and 83 each include loop type fasteners and the second refastening surfaces 84 and 85 each include complementary hook type fasteners. Alternatively, the refastening surfaces can include interlocking similar surface fasteners; adhesive or cohesive fastening elements such as an adhesive fastener and an adhesive-receptive landing zone or material; or the like. Although the illustrated embodiments show the back waist section 24 overlapping the front waist section 22, which is convenient, the training pant 20 can also be configured so that the front waist section overlaps the back waist section. Alternatively, the hook type fastener can be positioned to engage into the woven or nonwoven materials of the front or back side panels 34 and 134.

Loop type fasteners typically include a fabric or material having a base or backing structure and a plurality of loop members extending upwardly from at least one surface of the backing structure. The loop material can be formed of any suitable material, such as acrylic, nylon, polypropylene or polyester, and can be formed by methods such as warp knitting, stitch bonding or needle punching. Loop type materials can also include any fibrous structure capable of entangling or catching hook type materials, such as carded, spunbonded or other nonwoven webs or composites, including elastomeric and nonelastomeric composites. Suitable loop materials are available from Guilford Mills, Inc., Greensboro, N.C., U.S.A. under the trade designation No. 36549. Another suitable loop material can include a pattern un-bonded web as disclosed in U.S. Pat. No. 5,858,515 issued Jan. 12, 1999 to Stokes et al.

Hook type fasteners typically include a fabric or material having a base or backing structure and a plurality of hook members extending upwardly from at least one surface of the backing structure. In contrast to the loop type fasteners which desirably include a flexible fabric, the hook material advantageously includes a resilient material to minimize unintentional disengagement of the fastener components as a result of the hook material becoming deformed and catching on clothing or other items. The term “resilient” as used herein refers to an interlocking material having a predetermined shape and the property of the interlocking material to resume the predetermined shape after being engaged and disengaged from a mating, complementary interlocking material. Suitable hook material can be molded or extruded of nylon, polypropylene or another suitable material. Suitable single-sided hook materials for the refastening surfaces 82-85 are available from commercial vendors such as Velcro Industries B.V., Amsterdam, Netherlands or affiliates thereof, and are identified as Velcro HTH-829 with a unidirectional hook pattern and having a thickness of about 0.9 millimeters (35 mils) and HTH-851 with a unidirectional hook pattern and having a thickness of about 0.5 millimeters (20 mils); and Minnesota Mining & Manufacturing Co., St. Paul, Minn. U.S.A., including specific materials identified as CS-600.

With particular reference to FIG. 4, the first refastening surfaces 82 and 83 are desirably although not necessarily disposed on the body-contacting surface 28 of the pre-form 21 in the back waist section 24. The first refastening surfaces 82 and 83 are desirably positioned along the distal edges 68 of the back side panels 134, and abutting or adjacent to the waist end edge 72. In certain embodiments, for example, the first refastening surfaces 82 and 83 can be located within about 2 centimeters, and more particularly within about 1 centimeter, of the distal edges 68, the waist end edges 72, and the leg end edges 70.

With particular reference to FIG. 4, the second refastening surfaces 84 and 85 are desirably although not necessarily disposed on the outer surface 30 of the pre-form 21 in the front waist section 22. The second refastening surfaces 84 and 85 are sized to receive the first refastening surfaces 82 and 83 and are desirably positioned along the distal edges 68 of the front side panels 34, and abutting or adjacent to the waist end edge 72. In certain embodiments, for example, the second refastening surfaces 84 and 85 can be located within about 2 centimeters, and more particularly within about 1 centimeter, of the distal edges 68, the waist end edges 72, and the leg end edges 70. Where the first refastening surfaces 82 and 83 include loop type fasteners disposed on the inner surface 28 and the second refastening surfaces 84 and 85 include hook type fasteners disposed on the outer surface 30, the first refastening surfaces can be sized larger than the second refastening surfaces to ensure coverage of the rigid, outwardly-directed hooks.

The refastening surfaces 82-85 can be adhered to the side panels 34 and 134 by any means known to those skilled in the art such as adhesive bonds, ultrasonic bonds or thermal bonds. The refastening surfaces can include separate fastening elements or can include distinct regions of an integral material. For example, the pre-form 21 can include an integral second fastening material disposed in the front waist section 22 for refastenably connecting to the first refastening surfaces 82 and 83 at two or more different regions, which define the second refastening surfaces 84 and 85. In a particular embodiment, the refastening surfaces can include integral portions of the waist sections. For instance, one of the elastomeric front or back side panels can function as second fastening components in that they can include a material that is releasably engageable with refastening surfaces disposed in the opposite waist section.

The refastening surfaces are desirably rectangular, although they may alternatively be square, round, oval, curved or otherwise non-rectangularly shaped. In particular embodiments, each of the refastening surfaces 82-85 defines a length dimension aligned generally parallel with the longitudinal axis 48 of the pre-form 21 and a width dimension aligned generally parallel with the lateral axis 49 of the pre-form 21. For a child of about 9 to about 15 kilograms (20-30 pounds), for example, the length dimension of the refastening surfaces is desirably from about 5 to about 13 centimeters, such as about 10 centimeters, and the width dimension is desirably from about 0.5 to about 3 centimeters, such as about 1 centimeter. With particular embodiments, the refastening surfaces can have a length-to-width ratio of about 2 or greater, such as about 2 to about 25, and particularly about 5 or greater, such as about 5 to about 8. For other embodiments such as for adult products, it may be desirable for one or more of the refastening surfaces to include a plurality of relatively smaller fastening elements. In that case, a refastening surface or individual fastening elements may have an even smaller length-to-width ratio, for example, of about 2 or less, and even about 1 or less.

When the refastening surfaces 82-85 are releasably engaged, the side edges 36 of the absorbent chassis 32 in the crotch section 26 define the leg openings 52, and the waist edges 38 and 39 of the absorbent chassis, including the waist end edges 72 of the side panels, define the waist opening 50. For improved formation of the leg openings 52, it can be desirable in some embodiments for the front side panels 34 to be longitudinally spaced from the back side panels 134 (see FIG. 4). For example, the front side panels 34 can be longitudinally spaced from the back side panels 134 by a distance equal to about 20 percent or greater, particularly from about 20 to about 60 percent, and more particularly from about 35 to about 50 percent, of the overall length dimension of the absorbent article.

When connected, the refastening surfaces 82-85 form refastenable side seams 14 (FIG. 3) that desirably although not necessarily extend substantially the entire distance between the waist opening 50 and the leg openings 52. More specifically, the refastenable side seams 14 can cover about 80 to 100 percent, and particularly about 90 to about 98 percent, of the distance between the waist opening 50 and each leg opening 52, which distance is measured parallel to the longitudinal axis 48. To construct the side seams 14 to extend substantially the entire distance between the waist and leg openings 50 and 52, the refastening surfaces 82-85 can be formed to cover about 80 to 100 percent, and more particularly about 90 to about 98 percent, of the distance between the waist end edge 70 and the leg end edge 72 of the side panels 34 and 134. In other embodiments, the refastening surfaces can include a plurality of smaller fastening elements covering a smaller portion of the distance between the waist opening 50 and the leg openings 52, for example, about 20 to about 70 percent, but spaced apart to span a larger percentage of the distance between the waist opening and the leg openings.

For the refastenable side seams 14 to be located at the sides of the wearer, it can be particularly desirable for the lateral distance between the first refastening surfaces 82 and 83 to be substantially equal to the lateral distance between the second refastening surfaces 84 and 85. The lateral distance between a set of fasteners is measured parallel to the lateral axis 49 between the longitudinal center lines of the fasteners, measured with the side panels 34 and 134 in an unstretched condition.

In addition to the refastening surfaces 82-85, each waist section includes a sealing area 143, 145, 147 and 149 (illustrated on FIG. 4). A gripping area 163,165, 167 and 169 (also illustrated in FIG. 4) is located adjacent each sealing area 143, 145,147 and 149.

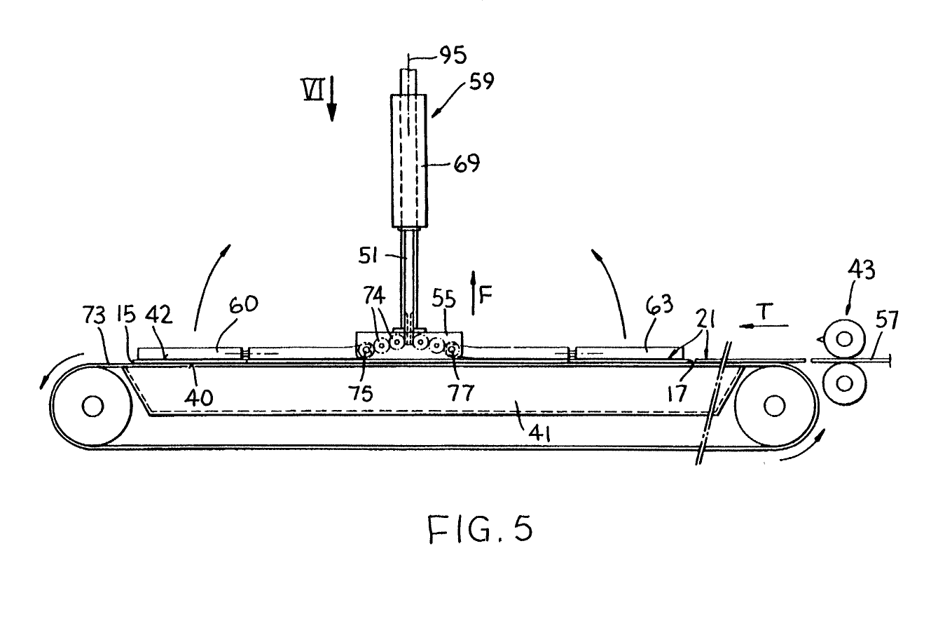

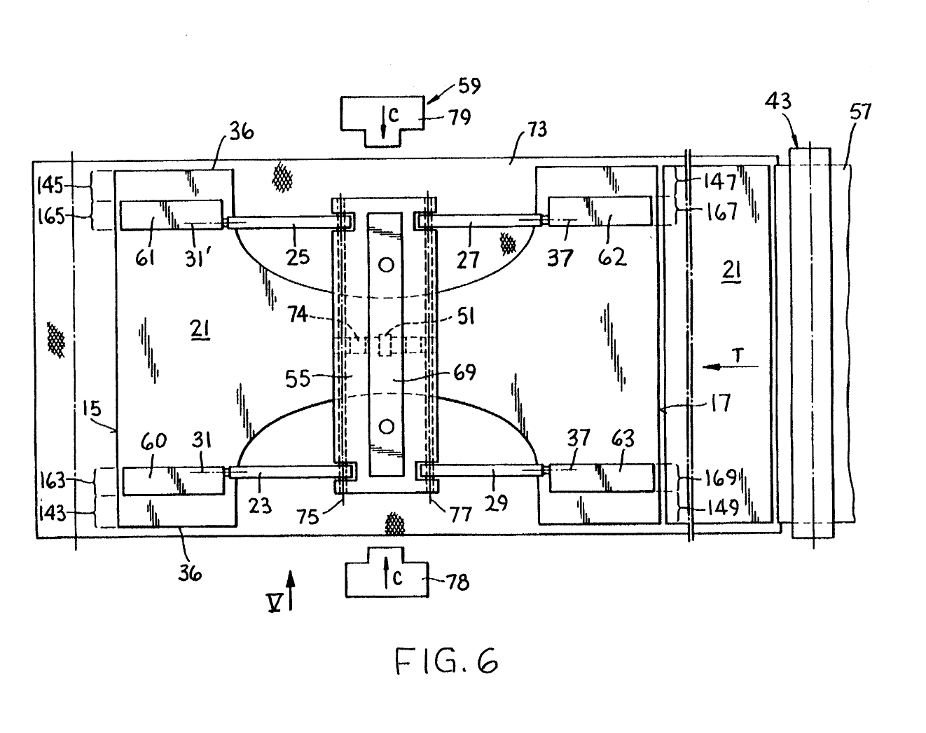

FIG. 5 shows a schematic side elevational view of the apparatus for forming an absorbent article having refastenable side seams according to the invention. FIG. 6 shows a top elevational view of the apparatus of FIG. 5. A continuous web 57 is transported in a substantially flattened state along a transport trajectory on a conveyor belt 73 in a direction of transport T. A cutting means 43 cuts the web laterally across its width to from individual blanks or pre-forms 21. The pre-forms 21 are transported in their substantially flattened state on the conveyor belt 73, which is air-permeable and runs over a suction box 41. By suction, the pre-forms 21 are held in a defined position on the conveyor belt 73, and the elastic elements 53, 54, 56 and 58 in the pre-forms 21 are prevented from contracting and from gathering the pre-forms 21.

As is shown in FIGS. 5 and 6, a folding-and-sealing unit 59 is located overhead of the conveyor belt 73 and includes gripping means 60, 61, 62 and 63. In FIG. 5 only gripping means 60 and 63 are visible. The gripping means are brought in contact with the body-contacting surface 28 of the pre-forms 21 at the four gripping areas 163, 165, 167 and 169. The gripping means 60-63 are rotatably mounted on carrier arms 23, 25, 27 and 29. The carrier arms 23, 25, 27 and 29 are connected to a frame 55 and can each be rotated around at least one hinging axis 75, 77. The hinging axes 75, 77 extend perpendicular to the plane of the drawing in FIG. 5, and generally perpendicular to the carrier arms 23, 25, 27 and 29.

As shown in FIG. 6, two sealing means 78, 79 are located on each side of the conveyor belt 73 and can be moved in a direction transversely to the direction of transport T to contact an anvil carrier 69. The sealing means 78, 79 may include heated elements which contact the anvil carrier 69 under pressures of between 1 and 105 psi. Because the anvil carrier 69 is simultaneously contacted by the sealing means 78, 79 from both sides and is squeezed between the sealing means, high pressures can be exerted on the side seams 12, 14, 16 and 18 without the need for a heavy and rigid suspension of the anvil carrier 69.

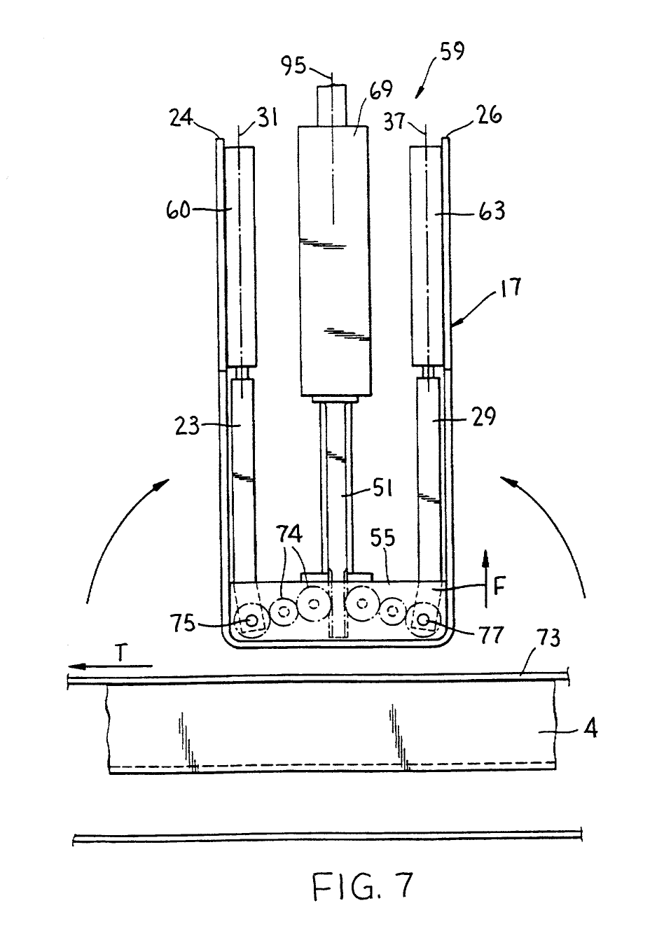

The carrier arms 23, 25, 27 and 29 can be rotated upwardly around the hinging axes 75, 77 to a position in which they extend substantially perpendicular to the conveyor belt 73, and such that the sealing areas 143, 145, 147 and 149 are brought in proximity of the anvil carrier 69. This is illustrated in FIG. 7. The actuating means for rotating the carrier arms 23, 25, 27 and 29 around the hinge axes 75, 77 may for instance be formed by levers or gears or any other known means.

As schematically indicated in FIG. 5, the carrier arm-actuating means for rotating the carrier arms around the hinging axes 75, 77 may include a number of gears 74. The gears 74 for instance engage with a complementary toothed surface on suspension arm 51. By moving the frame 55 along the suspension arm 51 towards the anvil carrier 69, the carrier arms 23, 25, 27 and 29 are rotated upwardly. The direction of rotation of the carrier arms 23, 25, 27 and 29 can in this embodiment be easily varied by selecting an even or uneven number of gears in the actuating means. Prior to, or during rotation of the carrier arms 23, 25, 27 and 29, the frame 55 and the anvil carrier 69 may in combination be lifted away from the conveyor belt 73 in the direction of the arrow F towards a sealing position.

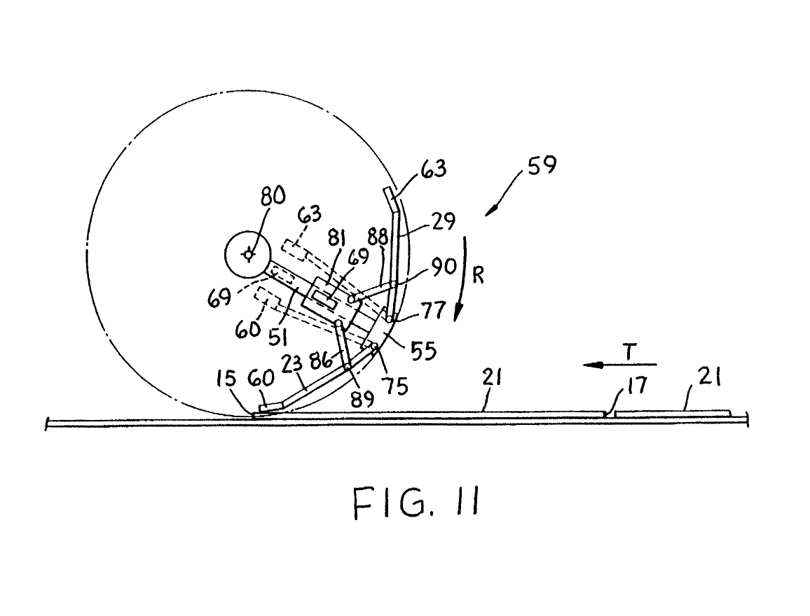

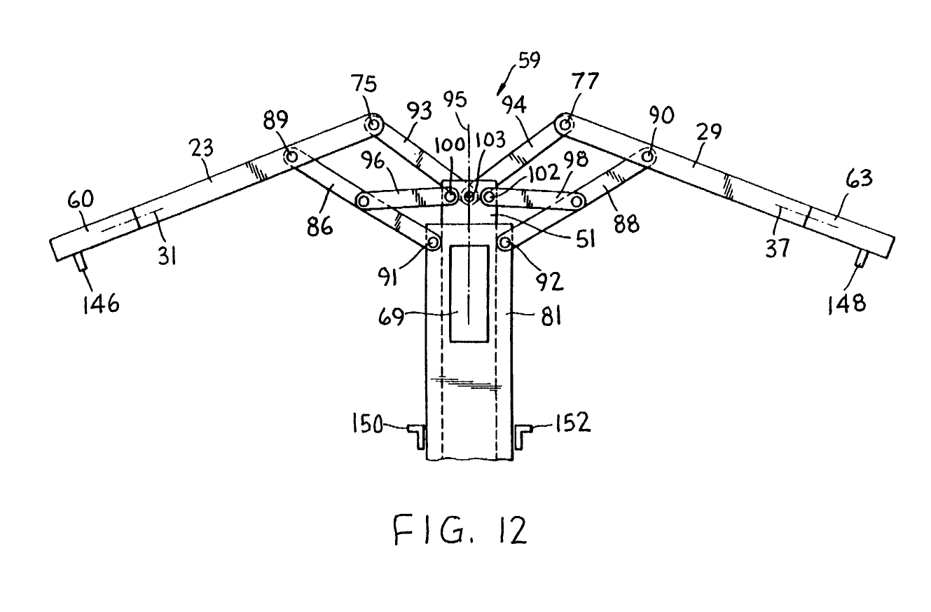

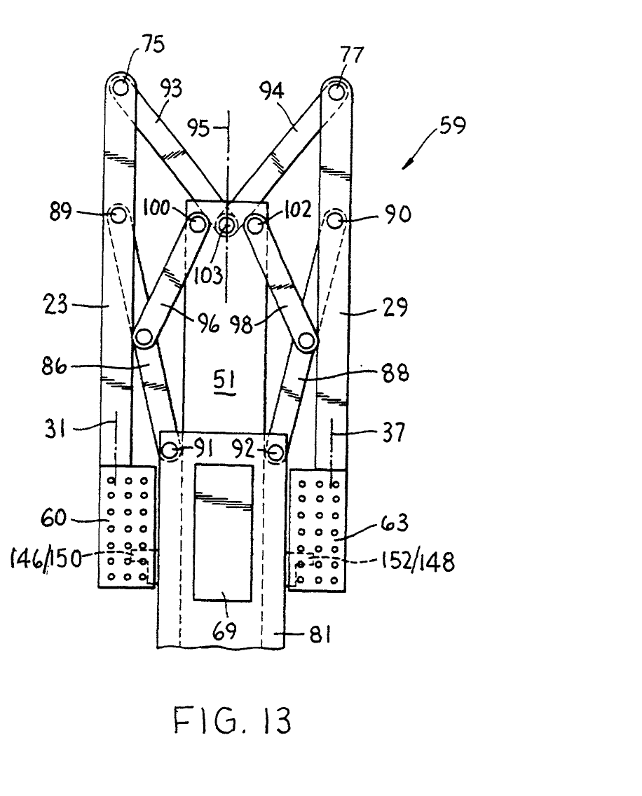

In the embodiment FIGS. 5, 6 and 7, the blank 21 can be stretched upon rotation of the carrier arms 23, 25, 27 and 29 around the hinging axes 75, 77. Stretching of the blank 21 can be prevented by hinging the carrier arms 23, 25, 27 and 29 around hinging axes 75, 77 which lie in the plane of the blank 21. For hinging axes that are not located in the plane of the blank 21 but above the plane of the blank 21, a length compensation is required. To counteract the increase in length of the blank 21 caused by rotating the carrier arms 23, 25, 27 and 29 upwardly, the folding-and-sealing unit 59 includes length-compensating means, which may for instance include a telescopic arrangement for varying the length of the carrier arms 23, 25, 27 and 29. In a preferred embodiment, the length-compensating means includes a suspension of at least one of the hinging axes 75, 77 which causes a varying distance between the hinging axes 75, 77 upon rotation of the carrier arms 23, 25, 27 and 29. This is shown in the preferred folding-and-sealing unit 59 of FIGS. 12 and 13.

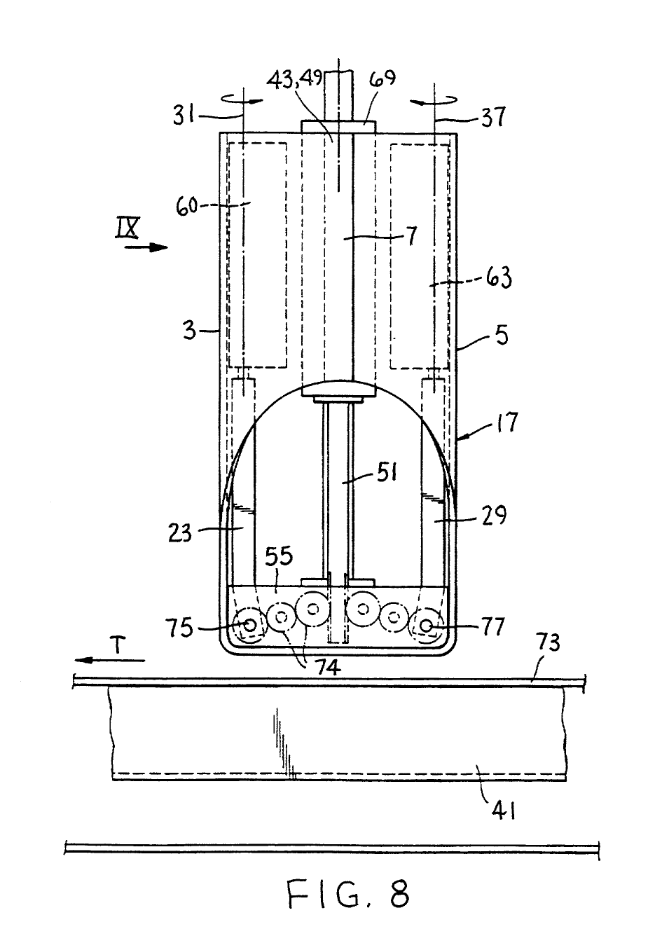

As illustrated in FIG. 8, the sealing areas 145, 147 and 143,149, respectively, are placed in an overlapping relationship by rotation of each gripping means 60-63 around a gripper axis 31,31′, 37,37′ that extends generally parallel to the carrier arms 23, 25, 27 and 29. The superimposed sealing areas 145,147 and 143,149 are contacted between the anvil carrier 69 and the sealing means 78,79, which may include an ultrasonic conductor. The ultrasonic energy imparted to the sealing areas puts the thermoplastic material of the sealing areas in a heat-softened state, such that upon compression of the sealing areas between the anvil and the conductors an overlapping side seam is formed.

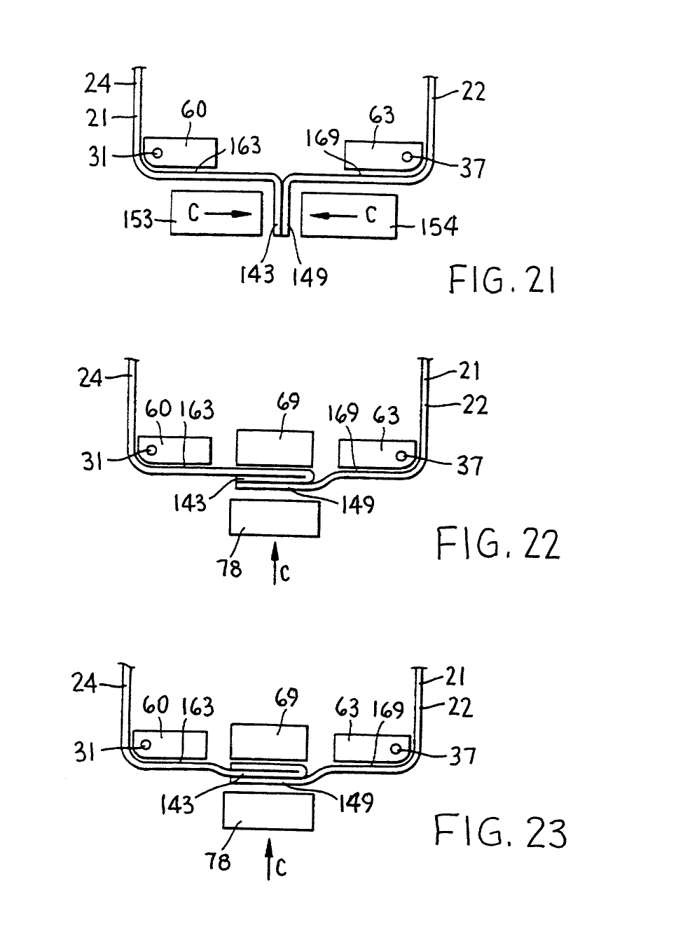

Instead of an overlapping seam, in which the sealing areas 143, 149 are superimposed generally parallel to the plane of the anvil carrier 69, the gripping means 6063 may be simultaneously rotated around their gripper axis 31,31′; 37,37′ in such a way that the sealing areas 143, 149 mutually abutt and extend generally perpendicular to the plane of the anvil carrier 69. Sealing can then occur for instance by compressing the abutting sealing areas 143, 149 in a direction generally parallel to the direction of transport T by sealing means traveling with folding-and-sealing unit 59 at matched speed. Different embodiments of overlapping and abutting side seams are shown in FIGS. 21 to 23.

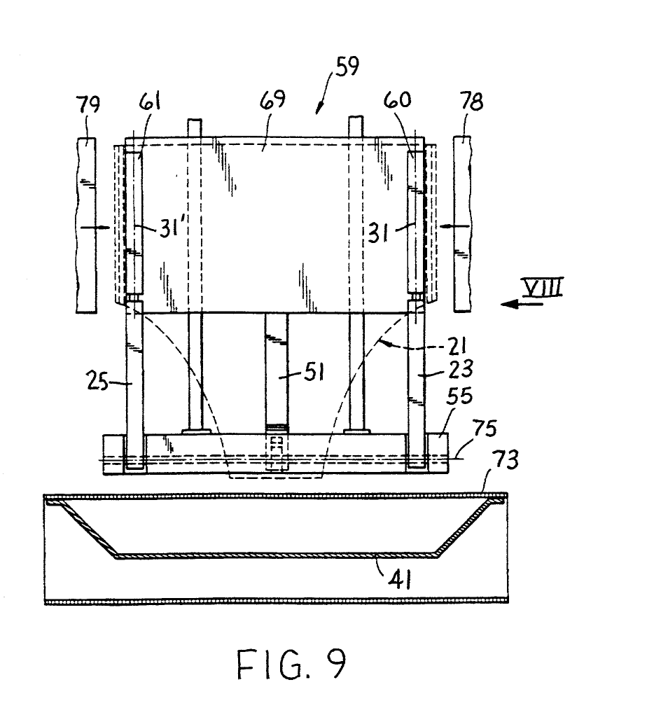

FIG. 9 shows a frontal view of the sealing unit 59 in the sealing position, prior to contacting the ultrasonic conductors 78, 79 with the anvil carrier 69. The pre-form 21 has been indicated by a dashed line. As upon rotation of the gripping means 60, 61 around the gripper axes 31, 31′ the pre-form 21 is stretched, the mutual distance between the gripping means 60, 61 is decreased upon rotation, for instance by displacing the gripping means along the hinging axis 75.

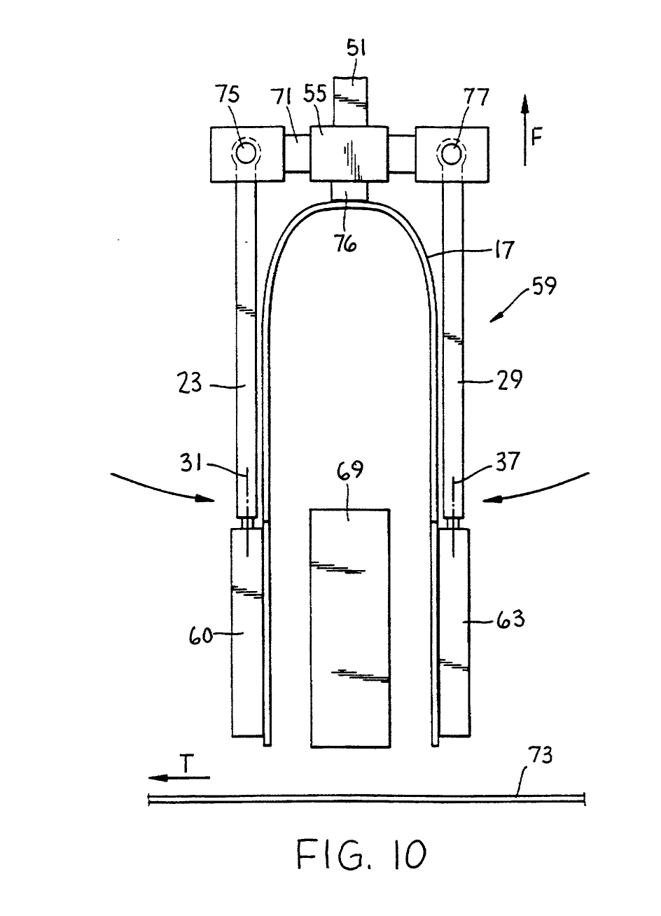

FIG. 10 shows a schematic side elevational view of a sealing unit, wherein the frame 55 is moved upwards in the direction of the arrow F, and wherein the carrier arms 23, 25, 27 and 29 are rotated downwardly after gripping the pre-form 21. In this case the folding of the pre-form 21 causes an excess of material of the pre-form 21 to be included between the gripping means 60 and 63. To maintain the pre-form 21 in a tensioned state, the carrier arms 23 and 29 may be moved outwardly along a transverse arm 71. To fix the pre-form 21 in place during folding, the center point of the pre-form 21 may be gripped by a gripping means 76 that may include for instance a vacuum suction device.

FIG. 11 shows a side elevational view of a preferred embodiment of a folding-and-sealing unit 59 for forming side seams at high speed. The carrier arms 23, 25, 27 and 29 are mounted on the frame 55 which forms an upper member. The frame 55 is mounted on the arm 51, which is rotated around a main axis 80 generally parallel to the hinging axes (75, 77) in the direction of the arrow R. The speed of rotation of the arm 51 around the main axis 80 is matched to the speed of transport of the pre-forms 21, and is such that the circumferential speed of the gripping means 60-63 equals the speed of transport. The leading edge 15 of a pre-form 21 is gripped by the gripping means 60, 61 at a moment when the relative velocity between the pre-form 21 and the gripping means 60, 61 is about zero. The geometry of the folding-and-sealing unit 59 is adapted to the length of the pre-form 21, and is such that gripping means 62,63 contact the trailing edge 17 of the pre-form 21 at the moment when the gripping means 62, 63 are tangential to the conveyor belt 73.

The carrier-arm actuating means in the embodiment of FIG. 11 includes a lower member 81 and for each carrier arm a connecting arm 86, 88. The connecting arms 86, 88 are connected in hinge points 89, 90 to the carrier arms 23, 25, 27 and 29 and are hingingly connected to the lower member 81. The lower member 81 is slidably mounted on the arm 51 such that the distance between the frame 55 and the lower member 81 can be varied. The carrier arms 23, 25, 27 and 29 are moved towards the anvil carrier 69, as indicated by the dashed lines, by moving the lower member 81 towards the main axis 80, while keeping the frame 55 stationary with respect to the arm 51. Evidently, it is also possible to move the carrier arms 23, 25, 27 and 29 to their sealing position by moving the frame 55 along the arm 51 away from a stationary lower member 81. The anvil carrier 69 is mounted on the arm 51 and is rotated together with the carrier arms 23, 25, 27 and 29.

FIGS. 12 and 13 show detailed cross-sectional views of the folding-and-sealing unit 59 in the gripping phase and in the sealing phase respectively, including the length-compensating means. The length compensating means includes two pivot arms 93, 94 to which the carrier arms 23, 25, 27 and 29 are connected. The pivot arms 93, 94 rotate around a central axis 103, that is connected to the arm 51. By rotation of the pivot arms 93, 94 around axis 103, the distance between the hinging axes 75, 77, which extend perpendicular to the plane of the drawing of FIGS. 12 and 13, is varied upon rotation of the carrier arms 23, 25, 27 and 29.

Furthermore, distance control arms 96, 98 are provided, which are on one side connected to the arm 51 and that have their opposite side attached to the connecting arms 86, 88. The distance control arms 96-98 couple the carrier arms 23, 25, 27 and 29 with the lower member 81 in such a manner that for each position of the lower member 81 along the arm 51, a single position of the carrier arms 23, 29 corresponds.

FIG. 13 shows the lower member 81 in its retracted position wherein the connecting arms 86, 88 have been pulled downwardly generally along the arm 51. The position of the connecting arms 86, 88, the distance control arms 96,98 and the pivot members 93,94 is uniquely determined for each position of the carrier arms 25, 29. When the connecting arms 86, 88 are pulled downwards by the lower member 81, the carrier arms 23, 25, 27 and 29 are rotated around the hinging axes 75, 77, while the hinging axes are moved along a circle segment which is centered on central axis 103.

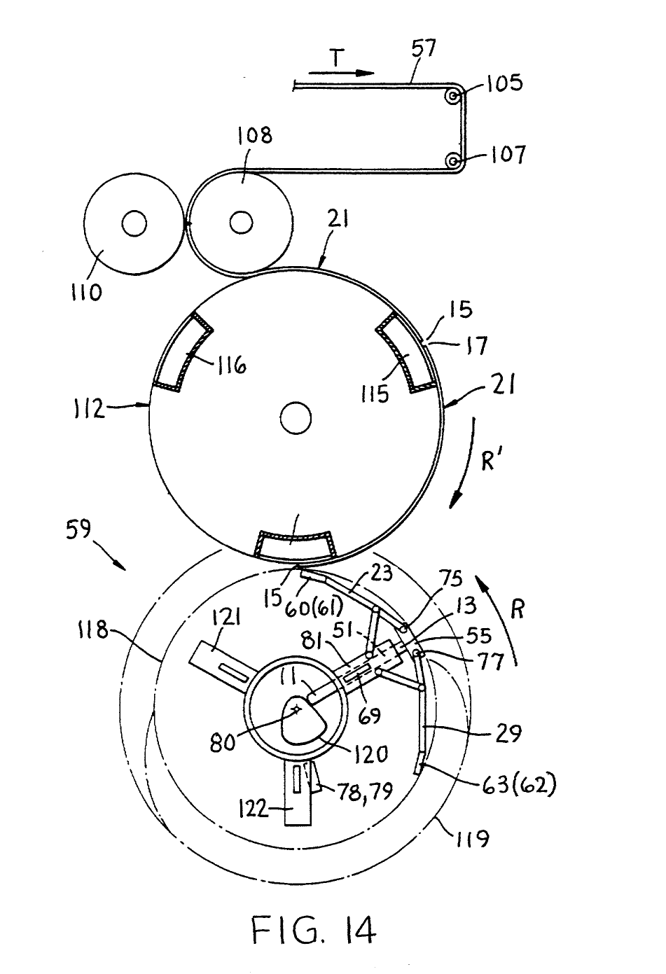

FIGS. 14-17 schematically show how from a continuous web 57, individual pre-forms 21 are cut and how the sealing steps of the sides of the blanks are affected in the preferred embodiment of a folding-and-sealing unit 59 in accordance with the invention. The web 57 is transported along transport means including guide rollers 105, 107, 108 towards a pick-up drum 112 which is rotated in the direction of the arrow R′. The leading edge 15 of the web 57 is sucked against a vacuum chamber 115 on the periphery of the drum 112, whereas the trailing edge, which in the embodiment of FIG. 14 is formed after cutting of the web in a cutting unit 110, is sucked onto the surface of drum 112 by vacuum chamber 116.

In the embodiment of FIG. 15 the web 57 is first placed across vacuum chambers 115 and 116, and is subsequently cut by cutting unit 110. Placing the cutting unit 110 tangential to the surface of the pick-up drum 112 allows for accurate control of the position of the trailing edge of each blank on the surface of the drum 112.

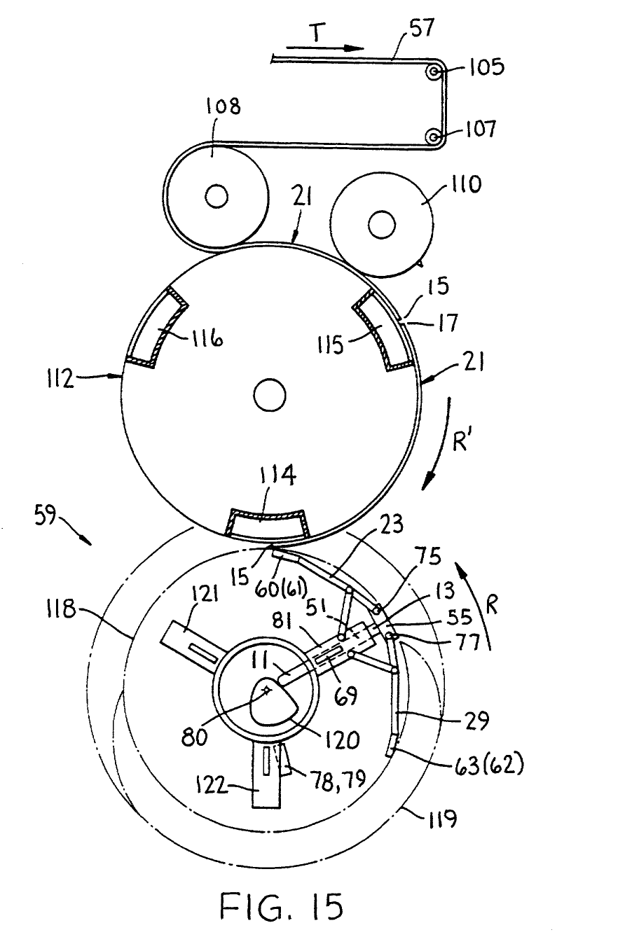

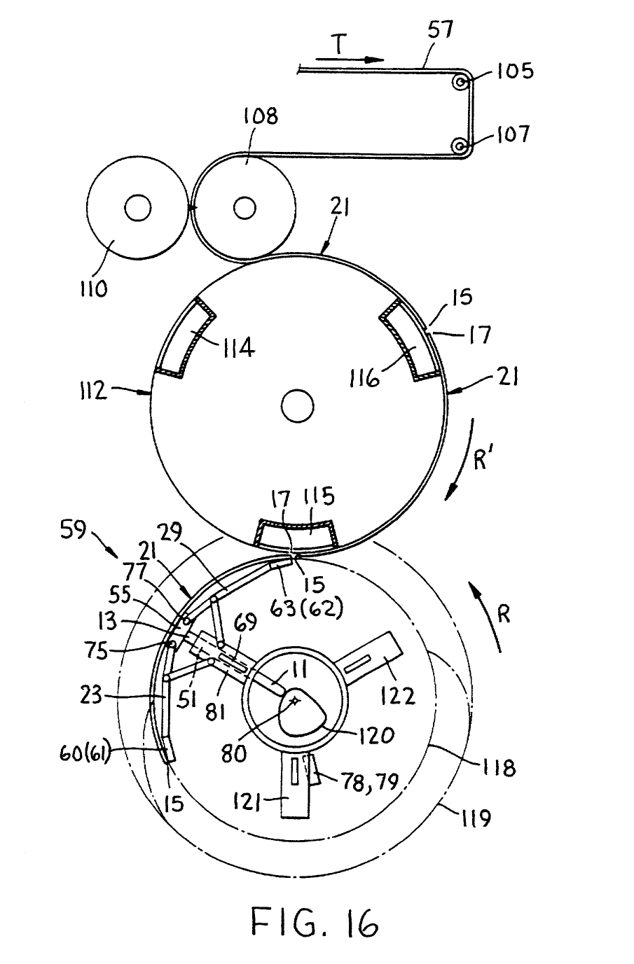

As shown in FIGS. 14 and 15 the gripping means 60, 61, 62 and 63 rotate on a circular track 118 that is tangential to the pick-up drum 112. The leading edge 15 of the pre-form 21 that is held on the drum 112 between the vacuum chamber 114 and 115, is gripped by the gripping means 60 and 61. Subsequently, as shown in FIG. 16, the trailing edge of the blank is gripped by gripping means 62 and 63 from the vacuum chamber 115.

In the embodiment of FIGS. 14-17, the arm 51 of the folding-and-sealing unit 59 includes an internal telescopic section, having an internal end including a cam follower 11 that is to engage a stationary cam surface 120. As shown in FIG. 17, the telescopic section 13 is pressed radially outwardly towards circular track 119 such that the frame 55 is radially displaced and the carrier arms are rotated towards the sealing position.

Inside the telescopic section 13, there may be included a further telescopic element that is to engage a further stationary cam surface, such that after the carrier arms have reached the sealing position, this element is pushed radially outwardly beyond the frame 55 to eject the finished sealed article from the folding-and-sealing unit 59. This construction has not been shown in the figures.

In the embodiment of FIGS. 14-17, a further set of carrier arms is located at each position 121,122. A single, stationary sealing means 79 such as an ultrasonic conductor is provided along which each set of carrier arms is rotated. For reasons of clarity only a single set of carrier arms has been shown in the FIGS. 14-17. As many as up to 30 identical sets of arms may be located around the main axis 80 to allow sufficient time for the sealing operation while maintaining a high speed of transport of the web 57, which may for instance be transported at speeds of 2 m/s or higher.

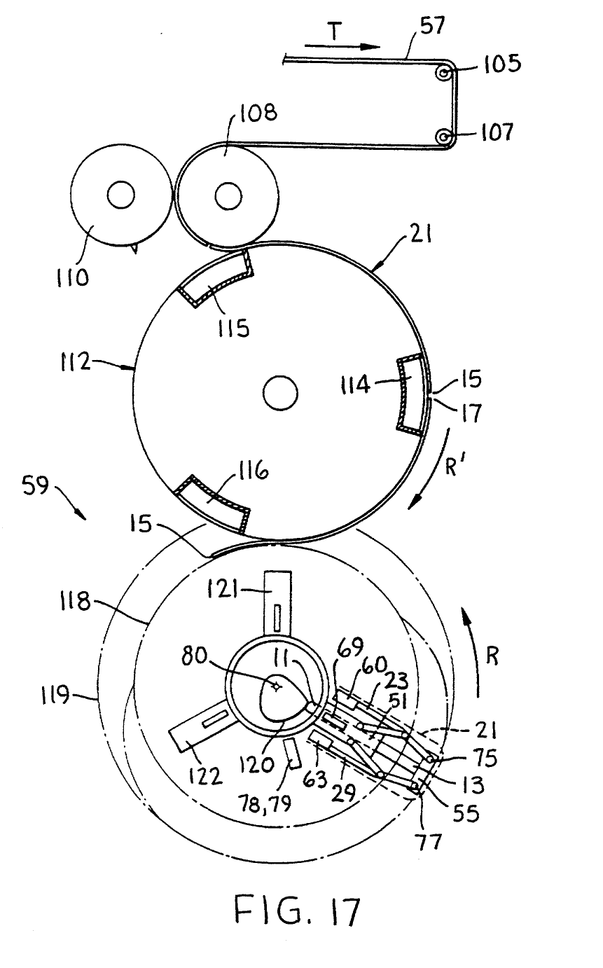

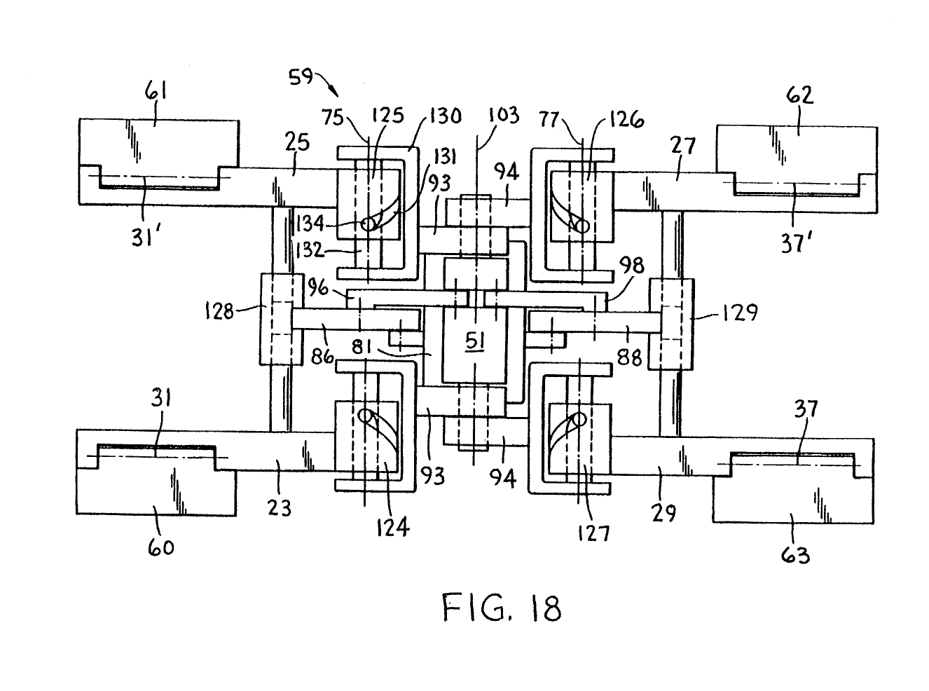

In an alternative embodiment, a sealing means 79 is provided for each folding-and-sealing unit at each position 121,122, and rotates with the folding-and-sealing units around the main axis 80. This allows, at a given speed of rotation around the axis 80, for sufficient time of interaction between the sealing means 79 and the material of the pre-form 21. Especially when the sealing means 79 are formed by heat-sealing means, it is important that sufficient time for heating up and cooling down of the side seam material is allowed. In an exemplary embodiment, the heat sealing means 79 require about 700 ms sealing time, which may correspond to a rotation of the sealing means 79 around the axis 80 of about 180 degrees. FIG. 18 shows a top cross sectional view of the folding-and-sealing unit 59, to more clearly depict the width-compensating means. Each carrier arm 23, 25, 27 and 29 is connected to a grooved member 124, 125,126 and 127. Each carrier arm 23, 25, 27 and 29 is mounted in a sleeve 128, 129 that is part of the pivot members 93,94. The following description is given with respect to gripping means 61, but equally applies to the other gripping means 60, 62 and 63. A grooved member 125 is mounted in a bracket 130, that is connected to the central axis 103 to be jointly rotated with the pivot member 93. The bracket 130 carries an axis 132 generally parallel to the hinging axes (75,77) on which a pin 134 is located which falls in a groove 131 of the member 125. Upon downward rotation of the carrier arm 25 around the hinging axis 75, the grooved member 125 is axially displaced along the axis 132, such that the distance between the gripping means 61 and 62 is decreased.

The gripping means 60-63 are preferably formed by vacuum gripping means. Each vacuum gripping means includes a hollow body having a plurality of outlets on a gripping surface to contact the gripping areas of the blank. Each hollow body of the gripping members is connected via a flexible vacuum lead to a switched vacuum supply. This has not been indicated in the figures.

As shown in FIGS. 12 and 13, the gripper actuating means for rotation of the gripping means 60-63 around the gripper axes 31,31′, 37,37′, includes a protrusion 146,148 on each gripping means and an engaging surface 150,152 mounted on the arm 51. When the carrier arms 23, 25, 27 and 29 are rotated to the sealing position in which they lie adjacent the arm 51, the protrusions 146, 148 are guided along the engaging surfaces 150,152 such that the gripping means are forced to rotate around the gripper axes 31,31′, 37,37′.

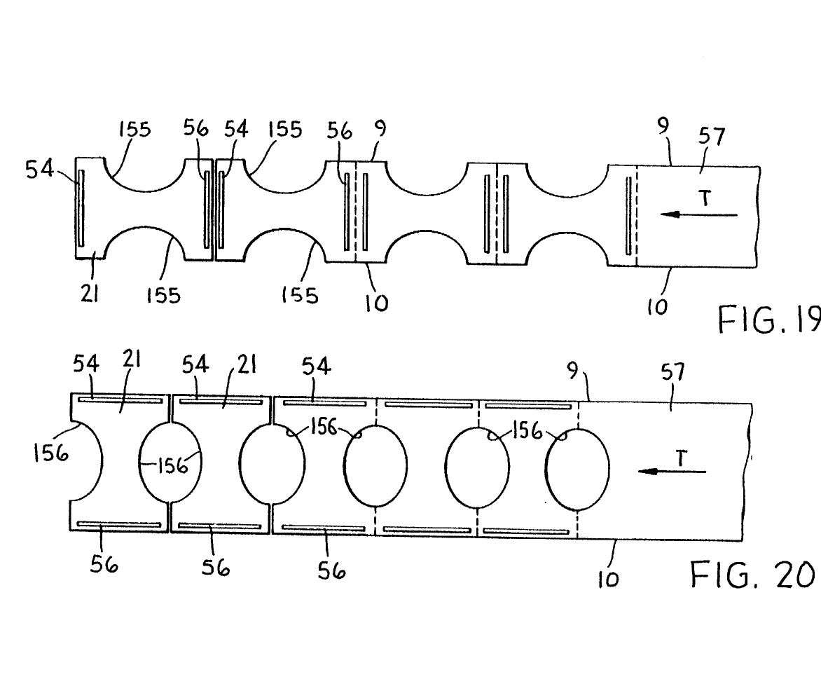

FIG. 19 shows a top plan view of the web 57, wherein the pre-forms 21 are oriented with their longitudinal sides in the direction of transport, T, of the web 57. Leg cut-out regions 155 are provided along the longitudinal sides 9, 10 of the web 57 and waist elastic elements 54, 56 are applied laterally or transversely across the web.

In the embodiment of FIG. 20, the pre-forms 21 are oriented laterally or transversely with respect to the web 57, such that the longitudinal sides of the pre-forms 21 correspond to the lateral or transverse sides of the web 57. In other words, the longitudinal sides of the pre-forms 21 are oriented perpendicularly to the direction of transport (“T”) of the web. The waist elastic elements 54, 56 are applied along and substantially parallel to the longitudinal sides of the web 57 such that they are maintained in an extended state at least during transport of the pre-forms and during the sealing step, the leg cut-out sections 156 extending through a central part of the web 57. In this embodiment, the pre-forms 21 may be rotated by 90°, either prior to, or after gripping by the gripping means 60-63, to align the pre-forms 21 with the direction of transport T.

FIG. 21 shows a schematic top view of the position of the sealing areas 143, 149 of the pre-form 21 upon formation of a butt-type side seam. The sealing means 153,154 compress the sealing areas 143,149 in the direction of the arrows C. The sealing means 153, 154 compress the sealing areas 143,149 together in order to bring the refastening surfaces 82, 84 into contact with each other.

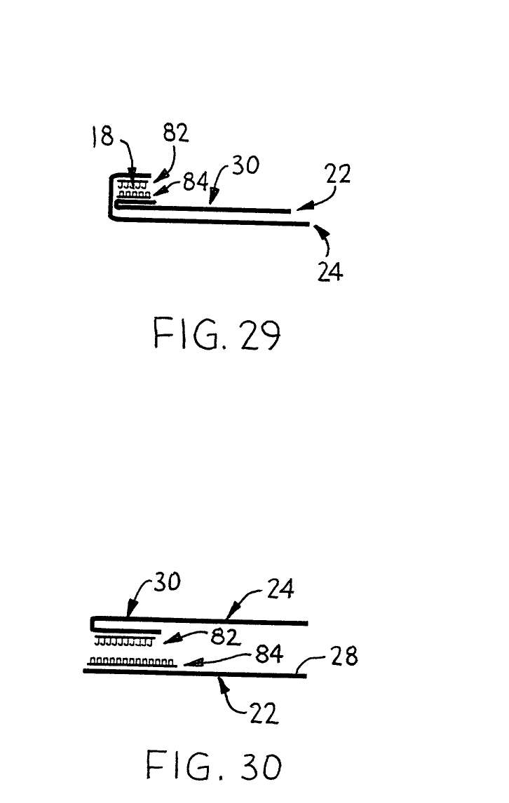

In the embodiment of FIG. 22, a side seam is formed that is a combination of a butt-type seam as shown in FIG. 2 and an overlapping seam as shown in FIG. 1. The seams of FIG. 22 can be obtained by first placing the sealing areas 143, 149 in an abutting relationship as shown in FIG. 21, and by subsequently doubling-over of the abutting sealing areas. The doubled-over abutting sealing areas 143, 149 are subsequently compressed between the sealing means 78 and the anvil carrier 69. The seam formed in this manner is particularly strong as three layers of material are included in the seam (see also FIG. 29).

FIG. 23 shows an overlapping seam in which three layers of material are included. In this embodiment, the sealing area 143 is doubled-over before placing it in a superimposed relationship with the sealing area 149. The doubled-over sealing area 143 may be obtained by doubling over one of the longitudinal edges 9, 10 of the web 57 before cutting of the individual pre-forms 21 and adhesively, or by heat-, or ultrasonic sealing, maintain the longitudinal edge in a doubled-over configuration. The doubled-over sealing area 143 may be desirable when the refastening surface 84 is formed by the backsheet 40.

As has already been described, the present invention is directed to methods of making undergarments having refastenable side seams from a substantially two-dimensional web. The general process by which the undergarment is formed has been described. However, the methods of the invention include a step of preconditioning the web 57 to include the refastening surfaces 82-85. Typically, the web 57 is preconditioned to include two, first refastening surfaces and two, second refastening surfaces. As has already been described, the two-dimensional web 57 has two longitudinal sides 9, 10 and a first lateral edge 7 that extends generally perpendicularly to the longitudinal sides.

“Preconditioning” of the web 57 can include the incorporation or application of the refastening surfaces 82-85 into or onto the web 57. The web materials themselves can be conditioned to form a refastening surface; for example, portions of the liner or outer cover can be configured to provide refastening surfaces. This type of preconditioning would result in refastenable surfaces 82-85 that are integral with the web 57. For example, nonwoven materials typically used as backsheet 40 and topsheet 42 materials can be selected to be engageable with hook material and other mechanical fasteners and therefore, to be refastening surfaces 82-85 (in these cases, either the first or the second refastening surfaces would still be preconditioned with a suitable mechanical fastening material). Additionally, separate refastening materials can be applied onto the web 57; for example, hook material and other mechanical fastening materials can be adhered or bonded to the web 57. The web 57 can be preconditioned to include more than one type of refastening surface. For example, it may be desirable to have one type of refastening surface 84, 85 on the portion of the web 57 that will eventually become the front waist section 22 of the garment 20 and another type of refastening surface 82, 83 on the portion of the web 57 that will eventually become the back waist section 24. Specifically, it may be desirable to apply a hook material to the portion of the web 57 that will form back waist sections 24 and to apply a loop material to the portion of the web 57 that will form front waist sections 22. The result using the methods of the invention will be that the hook and loop material surfaces will be brought into contact with each other and joined to form refastenable seams 12, 14 or 16, 18 on the undergarments 20 formed from the web 57.

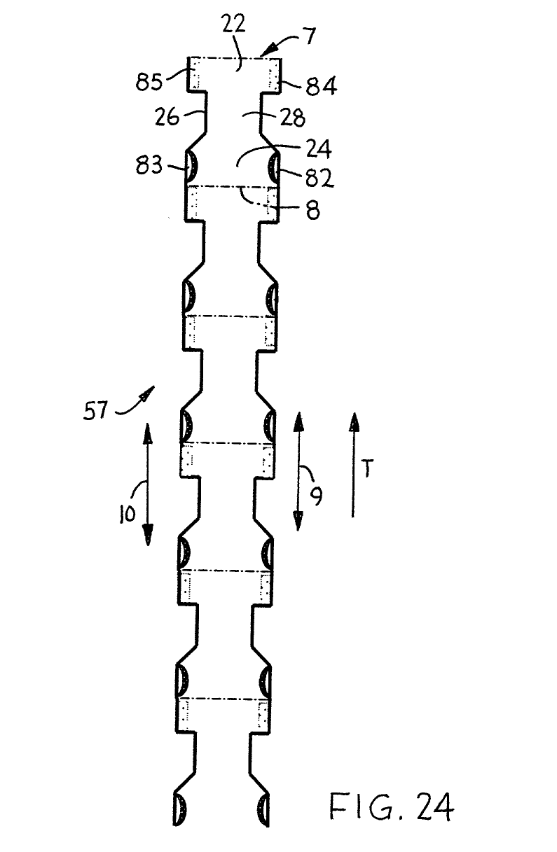

Referring to FIG. 24, an exemplary pre-conditioned web 57 is illustrated. The web 57 moves in a processing direction indicated by arrow T and the web 57 has two longitudinal sides 9, 10. The web 57 has a first lateral edge 7 which, in this figure, is aligned with a portion of the web 57 that will be formed into a front waist section 22 of a pre-form 21. Though the web is still continuous in FIG. 24, lines by which the web 57 will be cut along a second lateral edge 8 are shown in phantom. When the web 57 is cut along the second lateral edge 8, the resulting pre-form 21 will include the first and second lateral edges 7, 8 and the two longitudinal edges 9, 10 originating with the web 57. In this case, the undergarments are being formed in the “machine direction” and each longitudinal edge 9, 10 of the pre-form 21 will have two waist sections 22, 24 and a crotch section 26 located intermediate the waist sections 22, 24. As previously described, the pre-form 21, and initially the web 57, has an exterior surface 30 and a body-contacting surface 28 opposite the exterior surface 30. In FIG. 24, the body-contacting surface 28 is shown. In FIG. 24, the web 57 is pre-conditioned so that two of the refastening surfaces 84,85 are located on the exterior surface 30 of the front waist section 22 and two of the refastening surfaces 82, 83 are located on the body-contacting surface 28 of the back waist section 24. With this type of configuration, the refastenable side seams 12, 14 will be formed by overlapping the refastening surfaces (82 to 84 and 83 to 85) on the front and back waist sections 22, 24. In one aspect, the preconditioned web 57 of FIG. 24 includes a loop material at refastening surfaces 84, 85 and a hook material at refastening surfaces 82, 83.

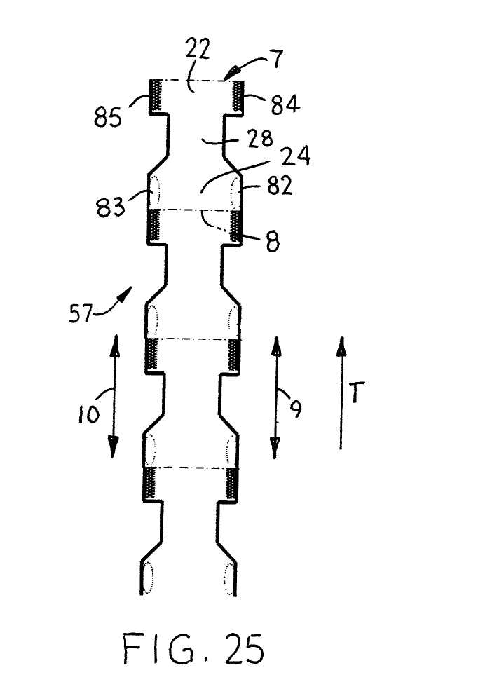

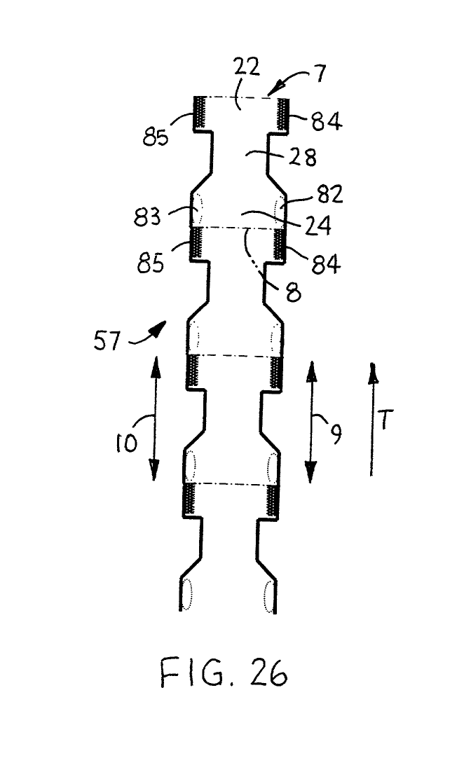

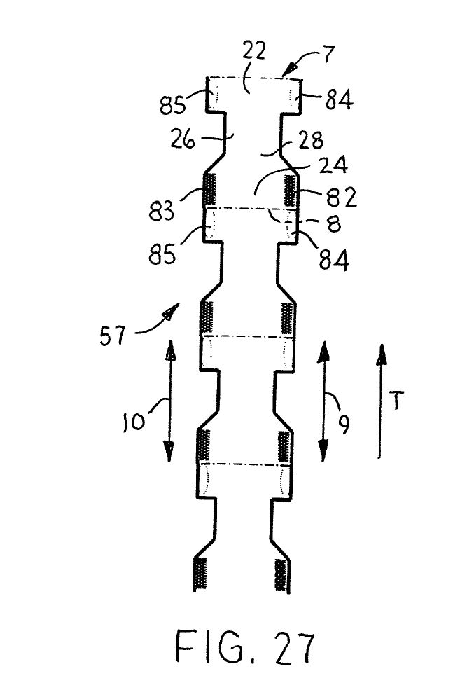

An alternative preconditioning of the web 57 is illustrated in FIG. 25. In this example, two of the refastening surfaces 84, 85 are located on the body-contacting surface 28 of the front waist section 22 and two of the refastening surfaces 82, 83 are located on the exterior surface 30 of the back waist section 24. In one aspect, the preconditioned web 57 of FIG. 25 includes a loop material at refastening surfaces 84, 85 and a hook material at refastening surfaces 82, 83. FIG. 26 illustrates another aspect of a preconditioned web 57 that is similar to the web 57 of FIG. 25 except that refastening surfaces 84, 85 are a hook material and refastening surfaces 82, 83 are a loop material. Likewise, FIG. 27 illustrates a web 57 that is similar to the web 57 of FIG. 24 except that the refastening surfaces 84, 85 are a hook material and refastening surfaces 82, 83 are a loop material. In each of FIGS. 24-27, the refastening surfaces 82-85 between portions of the web 57 that will become individual pre-forms 21, alternate between the exterior surface 30 and the body-contacting surface 28. Therefore, at the location of the web 57 forming the second lateral edge 8, there are refastening surfaces 82, 83 on one side of the web 57 adjacent to refastening surfaces 84, 85 on the opposite side of the web 57.

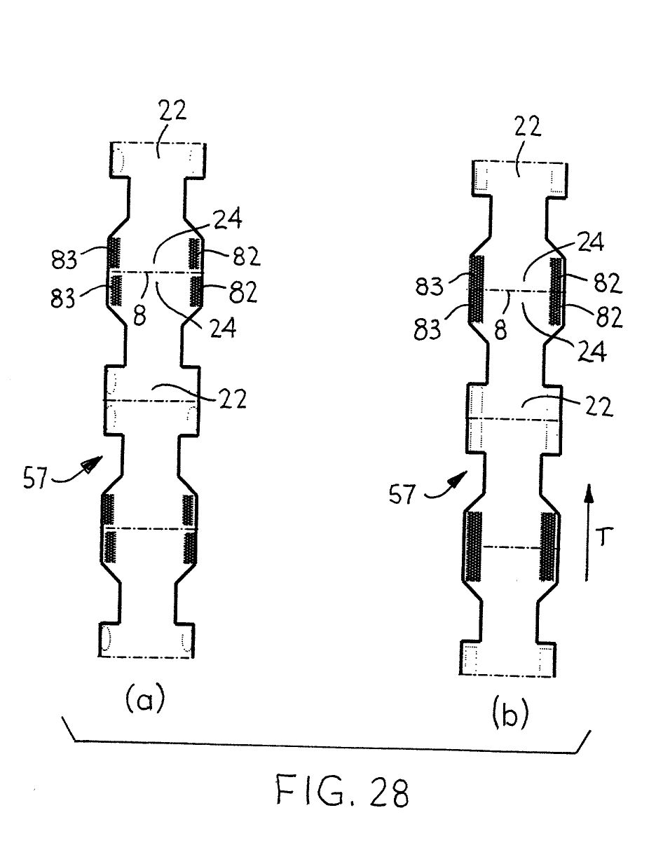

In another aspect, as depicted in FIG. 28, the refastening surfaces 82-85 can be pre-formed on the same side of the web 57 (either the exterior surface 30 or the body-contacting surface 28) as spanning or covering portions of the web 57 that will become adjacent pre-forms 21. When the web is preconditioned in this way, the refastening surfaces 82, 83 between adjacent back waist sections 24 can be separate as shown in FIG. 28(a) or they can be continuous as shown in FIG. 28(b). The continuous refastening surfaces 82, 83 are cut when the web 57 is cut along the second lateral edge 8.

The preconditioned webs 57 of FIGS. 24-28 will be formed into undergarments having their longitudinal direction 48 in the machine direction. In another aspect, a web 57 can be preconditioned in such a way to form undergarments having their longitudinal direction 48 in the cross direction. In that case, the web 57 has two lateral sides and a first longitudinal edge that extends generally perpendicularly to the lateral sides. When the web 57 is cut, it is cut along a second longitudinal edge to form a two-dimensional pre-form 21. The pre-form 21 includes the first and the second longitudinal edges and the two lateral edges. Each of the longitudinal edges includes two waist sections 22, 24 and a crotch section 26 located intermediate the waist sections 22, 24. As with undergarments formed in the machine direction, the refastening surfaces 82-85 are located adjacent and inboard on the waist sections 22, 24.

In another aspect of the present invention, the refastenable side seams 12, 14 can cover from about 80 to about 100 percent of the distance between the waist opening 50 and each leg opening 52. The distance is measured parallel to the longitudinal axis 48. More particularly, the refastenable side seams 12, 14 can cover from about 90 to about 98 percent of the distance between the waist opening 50 and each leg opening 52. In particular aspects, the refastenable side seams 12, 14 can cover at least a minimum of about 80 percent of the distance between the waist opening 50 and each leg opening 52. The refastenable side seams 12, 14 can alternatively cover about 90 percent of the distance. In other aspects, the refastenable side seams 12, 14 can be not more than a maximum of about 100 percent of the distance between the waist opening 50 and each leg opening 52. The refastenable side seams 12, 14 can alternatively be not more than about 98 percent of the distance. In yet another aspect of the present invention, the refastening surfaces 82-85 can include a plurality of smaller fastening elements that cover a smaller portion of the distance between the waist opening 50 and the leg openings 52. For example, the smaller fastening elements can have a length of from about 20 to about 70 percent of the length between the waist opening 50 and each leg opening 52, but can be spaced apart to span a larger percentage of the distance between the waist opening 50 and the leg openings 52.

The web 57 can also be preconditioned to include refastening surfaces 82-85 configured so that the refastenable side seams 16, 18 are formed by an abutting, or “butt”, type of seam. In this case, two of the refastening surfaces 84, 85 are located on the body-contacting surface 28 of the front waist section 22 and two of the refastening surfaces 82, 83 are located on the body-contacting surface 28 of the back waist section 24. When the refastening surfaces 82-85 are brought into contact with each other and joined, the butt-type seam 16, 18 can be folded inward toward the exterior surface 30 of the pre-form 21 and bonded down to the exterior surface 30 of the pre-form 21 (as depicted in FIG. 29). The seam 16, 18 can be bonded down by suitable known techniques including thermal, adhesive and ultrasonic bonding.

When two of the refastening surfaces 84, 85 are located on the exterior surface 30 of the front waist section 22 and two of the refastening surfaces 82, 83 are located on the body-facing surface 28 of the back waist section 24, the methods of the invention can further include a step of folding a portion of the longitudinal edge 36 of the front waist section 22 inward. Such a folding inward can facilitate joining of the superimposed refastening surfaces. The folding inward can be done prior to joint rotation of the gripping means 60-63. Similarly, two of the refastening surfaces 82, 83 can be located on the exterior surface 30 of the back waist section 24 and two of the refastening surfaces 84, 85 can be located on the body-facing surface 28 of the front waist section 22. In this case, a portion of the longitudinal edge 36 of the back waist section 24 can be folded inward prior to formation of the lap side seam. This configuration is illustrated in FIG. 30.

The methods of the invention can be used to condition a web 57 of nonwoven material(s) so that refastenable absorbent articles can be made. The web 57 can be preconditioned to include refastenable surfaces that can be brought together to form refastenable seams in a variety of configurations. The methods of the invention can be used to maintain control of the web 57 even though “free” areas of fastening material are present. Further, the methods of the invention are directed to folding and sealing individual pre-forms 21, not a continuous web.

While the invention has been described in detail with respect to specific aspects thereof, it will be appreciated that those skilled in the art, upon attaining an understanding of the foregoing, may readily conceive of alterations to, variations of and equivalents to these aspects. Accordingly, the scope of the present invention should be assessed as that of the appended claims and any equivalents thereto.

We claim:

1. Method of making an undergarment having refastenable side seams from a substantially two-dimensional web, the web having two longitudinal sides and a first lateral edge extending perpendicularly to the longitudinal sides, the method comprising the steps of:
preconditioning the web to include at least four refastening surfaces;
transporting the web in a processing direction;
cutting the web along a second lateral edge to form a two-dimensional pre-form that includes the first and the second lateral edges and the two longitudinal edges; each longitudinal edge having two waist sections and a crotch section located intermediate the waist sections; the refastening surfaces are located adjacent and inboard on the waist sections;
gripping the pre-form adjacent each waist section with a gripping means in four gripping areas, each gripping area being located near a respective refastening surface;
jointly rotating at least the gripping means which hold the gripping areas in the region of one of the lateral edges around at least one hinging axis extending substantially parallel to the lateral edges of the pre-form to place the first lateral edge generally parallel and opposite to the second lateral edge;
superimposing the refastening surfaces in a contacting relationship;
joining the superimposed refastening surfaces in a securing means, thus forming the undergarment; and
releasing the undergarment from the gripping means.

2. The method of claim 1, further comprising the step of forming the web by combining a liquid-impervious backsheet, an absorbent core and a liquid-pervious topsheet, such that the undergarment is an absorbent article.

3. The method of claim 1 wherein the pre-form includes an exterior surface and a body-contacting surface opposite the exterior surface; and the waist sections define a front waist section and a back waist section.

4. The method of claim 3, wherein two of the refastening surfaces are located on the exterior surface of the front waist section and two of the refastening surfaces are located on the body-contacting surface of the back waist section.

5. The method of claim 3, wherein two of the refastening surfaces are located on the body-contacting surface of the front waist section and two of the refastening surfaces are located on the exterior surface of the back waist section.

6. The method of claim 3, wherein, prior to cutting of the web, there are portions of the web that will form adjacent pre-forms and the adjacent pre-forms are joined to each other by the back waist section of one pre-form and the back waist section of the adjacent pre-form.

7. The method of claim 3, wherein, prior to cutting of the web, there are portions of the web that will form adjacent pre-forms and the adjacent pre-forms are joined to each other by the back waist section of one pre-form and the front waist section of the adjacent pre-form.

8. The method of claim 4, further comprising a step of folding inward a portion of the longitudinal edge of the front waist section prior to jointly rotating the gripping means to facilitate joining of the superimposed refastening surfaces.

9. The method of claim 3, wherein two of the refastening surfaces are located on the body-contacting surface of the front waist section and two of the refastening surfaces are located on the body-contacting surface of the back waist section.

10. The method of claim 9, further comprising a step of folding inward toward the exterior surface of the pre-form the joined superimposed refastening surfaces and bonding the joined superimposed refastening surfaces to the exterior surface of the pre-form.

11. Method of making an undergarment having refastenable side seams from a substantially two-dimensional web, the web having two lateral sides and a first longitudinal edge extending perpendicularly to the lateral sides, the method comprising the steps of:
preconditioning the web to include at least four refastening surfaces;
transporting the web in a processing direction;
cutting the web along a second longitudinal edge to form a two-dimensional pre-form that includes the first and the second longitudinal edges and the two lateral edges; each longitudinal edge having two waist sections and a crotch section located intermediate the waist sections; the refastening surfaces are located adjacent and inboard on the waist sections;
gripping the pre-form adjacent each waist section with a gripping means in four gripping areas, each gripping area being located near a respective refastening surface;
jointly rotating at least the gripping means which hold the gripping areas in the region of one of the lateral edges around at least one hinging axis extending substantially parallel to the lateral edges of the pre-form to place one of the lateral edges generally parallel and opposite to the other lateral edge;
superimposing the refastening surfaces in a contacting relationship;
joining the superimposed refastening surfaces in a securing means, thus forming the undergarment; and
releasing the undergarment from the gripping means.

12. Method of making an undergarment having refastenable side seams from a substantially two-dimensional web, the web having two longitudinal sides and a first lateral edge extending perpendicularly to the longitudinal sides, the method comprising the steps of:
preconditioning the web to include at least two areas of hook material and two areas of mating loop material;
transporting the web in a processing direction;
cutting the web along a second lateral edge to form a two-dimensional pre-form that includes the first and the second lateral edges and the two longitudinal edges; each longitudinal edge having two waist sections and a crotch section located intermediate the waist sections; the areas of hook material and areas of mating loop material are located adjacent and inboard on the waist sections;
gripping the pre-form adjacent each waist section with a gripping means in four gripping areas, two of the gripping areas being located near respective areas of hook material and two of the gripping areas being located near respective areas of mating loop material;
jointly rotating at least the gripping means which hold the gripping areas in the region of one of the lateral edges around at least one hinging axis extending substantially parallel to the lateral edges of the pre-form to place the first lateral edge generally parallel and opposite to the second lateral edge;
superimposing the areas of hook material with the areas of mating loop material in a contacting relationship;
joining the superimposed areas of hook material and areas of mating loop material in a securing means, thus forming the undergarment; and
releasing the undergarment from the gripping means.

13. The method of claim 12, further comprising the step of forming the web by combining a liquid-impervious backsheet, an absorbent core and a liquid-pervious topsheet, such that the undergarment is an absorbent article.

14. The method of claim 12 wherein the pre-form includes an exterior surface and a body-contacting surface opposite the exterior surface; and the waist sections define a front waist section and a back waist section.

15. The method of claim 14, wherein the areas of mating loop material are located on the exterior surface of the front waist section and the areas of hook material are located on the body-contacting surface of the back waist section.

16. The method of claim 14, wherein the areas of hook material are located on the exterior surface of the front waist section and the areas of mating loop material are located on the body-contacting surface of the back waist section.

17. The method of claim 14, wherein the areas of mating loop material are located on the body-contacting surface of the front waist section and the areas of hook material are located on the exterior surface of the back waist section.

18. The method of claim 14, wherein the areas of hook material are located on the body-contacting surface of the front waist section and the areas of mating loop material are located on the exterior surface of the back waist section.

19. The method of claim 14, wherein, prior to cutting of the web, there are portions of the web that will form adjacent pre-forms and the adjacent pre-forms are joined to each other by the back waist section of one pre-form and the back waist section of the adjacent pre-form.

20. The method of claim 14, wherein, prior to cutting of the web, there are portions of the web that will form adjacent pre-forms and the adjacent pre-forms are joined to each other by the back waist section of one pre-form and the front waist section of the adjacent pre-form.

21. The method of claim 14, wherein the areas of hook material are located on the body-contacting surface of the front waist section and the areas of mating loop material are located on the body-contacting surface of the back waist section.

22. The method of claim 14, wherein the areas of mating loop material are located on the body-contacting surface of the front waist section and the areas of hook material are located on the body-contacting surface of the back waist section.

23. The method of claim 22, further comprising a step of folding inward to the exterior surface of the pre-form the joined superimposed areas of hook material and areas of loop material and bonding the joined superimposed areas of hook material and areas of loop material to the exterior surface of the pre-form.
